(19) United States
(12) Patent Application Publication
(10) Pub. No.: US 2012/0062570 A1
(43) Pub. Date: Mar. 15, 2012

(54) PROCESS OF FORMING AN AIR GAP IN A MICROELECTROMECHANICAL SYSTEM DEVICE USING A LINER MATERIAL

(75) Inventor: Marc Maurice MIGNARD, San Jose, CA (US)

(73) Assignee: QUALCOMM MEMS TECHNOLOGIES, INC., San Diego, CA (US)

(21) Appl. No.: 13/175,497

(22) Filed: Jul. 1, 2011

Related U.S. Application Data
(60) Provisional application No. 61/381,776, filed on Sep. 10, 2010.

(51) Int. Cl. G06T 1/00; B05D 5/12; B32B 38/10; B32B 3/10

(52) U.S. Cl. 345/501; 428/201; 427/100; 156/280

(57) ABSTRACT

This disclosure provides systems, methods and apparatus for forming an air gap in an EMS device without using a sacrificial layer in the air gap. In some implementations, a support structure is formed on the substrate, and a sacrificial substrate is provided on the support structure. A liner material is deposited on the substrate, the support structure, and the sacrificial substrate, for instance, via an atomic layer deposition (ALD) process. The sacrificial substrate can be removed, and a top layer material can be deposited on the exposed areas of the support structure and the liner material. The liner material defines an air gap between the substrate and the top layer material.

### CROSS-REFERENCE TO RELATED APPLICATIONS

This application claims benefit under 35 U.S.C. §119(e) to U.S. Provisional Patent Application No. 61/381,776, filed Sep. 10, 2010, which is herein incorporated by reference.

### TECHNICAL FIELD

This disclosure relates generally to microelectromechanical system devices and more particularly to fabrication methods for microelectromechanical system devices.

### DESCRIPTION OF RELATED TECHNOLOGY

Electromechanical systems include devices having electrical and mechanical elements, actuators, transducers, sensors, optical components (such as mirrors) and electronics. Electromechanical systems can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers.

One type of electromechanical systems (EMS) device is called an interferometric modulator (IMOD). As used herein, the term interferometric modulator or interferometric light modulator refers to a device that selectively absorbs and/or reflects light using the principles of optical interference. In some implementations, an interferometric modulator may include a pair of conductive plates, one or both of which may be transparent and/or reflective, wholly or in part, and capable of relative motion upon application of an appropriate electrical signal. In an implementation, one plate may include a stationary layer deposited on a substrate and the other plate may include a metallic membrane separated from the stationary layer by an air gap. The position of one plate in relation to another can change the optical interference of light incident on the interferometric modulator. Interferometric modulator devices have a wide range of applications, and are anticipated to be used in improving existing products and creating new products, especially those with display capabilities.

Electromechanical elements may be created using deposition, etching, lithography, and/or other micromachining processes that etch away parts of substrates and/or deposited material layers, or that add layers to form electrical and electromechanical devices. Air gaps, regions in a structure where layers of material are separated by an open space, in EMS devices are commonly created during the fabrication process. These air gaps may be used for various purposes. For example, air gaps can contain transducers for the EMS device. Air gaps also may collapse. For example, the two separated layers of material can be made to come into contact with one another, and then return to their original state during the EMS device operation. One conventional technique in which air gaps are created in EMS devices is by depositing and patterning a sacrificial material on a material layer, depositing additional material layers on top of the sacrificial material, and then removing the sacrificial material. This process creates an air gap between the material layer and the additional material layers. It may be desirable to find alternative methods for forming air gaps.

### SUMMARY

The systems, methods and devices of the disclosure each have several innovative aspects, no single one of which is solely responsible for the desirable attributes disclosed herein.

One innovative aspect of the subject matter described in this disclosure can be implemented in a method of fabricating an EMS device. A liner material is deposited on an area of a surface of a substrate, exposed surfaces of a support structure, and an interior surface of a sacrificial substrate. The area of the surface of the substrate is exposed by the support structure on the surface of the substrate. The sacrificial substrate is on the support structure. The interior surface of the sacrificial substrate is facing and is spaced apart from the area of the surface of the substrate. The sacrificial substrate is removed to expose a first area of the liner material. A top layer material is deposited on the first area of the liner material. The area of the surface of the substrate and the top layer material are separated from one another by an open space defined by the liner material.

One innovative aspect of the subject matter described in this disclosure can be implemented in a method of fabricating an EMS device. A photoresist is deposited on an interior surface of a sacrificial substrate. The photoresist is configured to bond the sacrificial substrate to a support structure on a surface of a substrate. The support structure includes a plurality of posts exposing an area of the surface of the substrate. The sacrificial substrate is bonded to the support structure. The interior surface of the sacrificial substrate is facing and is spaced apart from the area of the surface of the substrate. A liner material is deposited via an atomic layer deposition process on the area of the surface of the substrate, a portion of the support structure, and the interior surface of the sacrificial substrate. The sacrificial substrate is removed by releasing the photoresist to expose an area of the support structure and an area of the liner material. A top layer material is deposited on the area of the support structure and the area of the liner material. The area of the surface of the substrate and the top layer material are separated from one another by an open space defined by the liner material.

One innovative aspect of the subject matter described in this disclosure can be implemented in an apparatus. The apparatus includes a substrate having a surface. A support structure is on the surface of the substrate. A top layer material is on the support structure. The top layer material, the substrate, and the support structure together define an open space. A liner material is on surfaces of the top layer material, the substrate, and the support structure that face the open space. The liner material has a thickness large enough such that the liner material would not break during deposition of the top layer material.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

The included drawings are for illustrative purposes and serve only to provide examples of possible structures and process steps for the disclosed processes, apparatus, and systems for forming air gaps in microelectromechanical system (MEMS) devices.

FIG. 1 shows an example of an isometric view depicting two adjacent pixels in a series of pixels of an interferometric modulator (IMOD) display device.

FIG. 2 shows an example of a system block diagram illustrating an electronic device incorporating a 3×3 interferometric modulator display.

FIG. 3 shows an example of a diagram illustrating movable reflective layer position versus applied voltage for the interferometric modulator of FIG. 1.

FIG. 4 shows an example of a table illustrating various states of an interferometric modulator when various common and segment voltages are applied.

FIG. 5A shows an example of a diagram illustrating a frame of display data in the 333 3 interferometric modulator display of FIG. 2.

FIG. 5B shows an example of a timing diagram for common and segment signals that may be used to write the frame of display data illustrated in FIG. 5A.

FIG. 6A shows an example of a partial cross-section of the interferometric modulator display of FIG. 1.

FIGS. 6B-6E show examples of cross-sections of varying implementations of interferometric modulators.

FIG. 7 shows an example of a flow diagram illustrating a manufacturing process for an interferometric modulator.

FIGS. 8A-8E show examples of cross-sectional schematic illustrations of various stages in a method of making an interferometric modulator.

FIG. 9 shows an example of a flow diagram illustrating a method of forming an air gap of an EMS device.

FIG. 10A shows an example of a portion of a substrate and the materials deposited on the substrate, while FIG. 10B shows cross-sectional views of the substrate at various stages corresponding to the flow diagram of FIG. 9.

FIG. 11 shows an example in which a support structure is removed.

FIG. 12 shows an example of a configuration of a support structure.

FIG. 13A shows an example of a portion of a substrate and the materials deposited on the substrate, while FIG. 13B shows cross-sectional views of the substrate at various stages corresponding to the flow diagram of FIG. 9.

FIGS. 14A and 14B show examples of system block diagrams illustrating a display device that includes a plurality of interferometric modulators.

Like reference numbers and designations in the various drawings indicate like elements.

### DETAILED DESCRIPTION

The following detailed description is directed to certain implementations for the purposes of describing the innovative aspects. However, the teachings herein can be applied in a multitude of different ways. The described implementations may be implemented in any device that is configured to display an image, whether in motion (e.g., video) or stationary (e.g., still image), and whether textual, graphical or pictorial. More particularly, it is contemplated that the implementations may be implemented in or associated with a variety of electronic devices such as, but not limited to, mobile telephones, multimedia Internet enabled cellular telephones, mobile television receivers, wireless devices, smartphones, bluetooth devices, personal data assistants (PDAs), wireless electronic mail receivers, hand-held or portable computers, netbooks, notebooks, smartbooks, tablets, printers, copiers, scanners, facsimile devices, GPS receivers/navigators, cameras, MP3 players, camcorders, game consoles, wrist watches, clocks, calculators, television monitors, flat panel displays, electronic reading devices (e.g., e-readers), computer monitors, auto displays (e.g., odometer display, etc.), cockpit controls and/or displays, camera view displays (e.g., display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, parking meters, washers, dryers, washer/dryers, packaging (e.g., electromechanical systems (EMS), MEMS and non-MEMS), aesthetic structures (e.g., display of images on a piece of jewelry) and a variety of electromechanical systems devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes, electronic test equipment. Thus, the teachings are not intended to be limited to the implementations depicted solely in the Figures, but instead have wide applicability as will be readily apparent to one having ordinary skill in the art.

Disclosed are methods of forming air gaps during the fabrication of an EMS device. In implementations of the methods, a support structure formed on a substrate and a sacrificial substrate on the support structure define open spaces in a device. A liner material is deposited on the substrate, the support structure, and the sacrificial substrate surrounding the open spaces. After deposition of the liner material, the sacrificial substrate is removed to expose the support structure and the liner material. A top layer material is deposited on the support structure and the liner material, with the liner material defining an air gap between top layer material and the substrate. Implementations of the methods may be used for the fabrication of air gaps in any number of different EMS devices, including gyroscopes, accelerometers, pressure sensors, and microphones.

Particular implementations of the subject matter described in this disclosure can be implemented to realize one or more of the following potential advantages. Implementations of the methods may be used to form an air gap in an EMS device without removing a sacrificial material from a volume or a cavity defining the air gap. For example, when removing a sacrificial material from a volume or a cavity defining an air gap, etchants may leave reactant residues within the volume or cavity after removing the sacrificial material or the etchants may be otherwise difficult to use. Forming an air gap with the use of a liner material obviates the need to remove a sacrificial material from a volume or a cavity defining an air gap.

An example of a suitable MEMS or EMS device, to which the described methods and implementations may apply, is a reflective display device. Reflective display devices can incorporate interferometric modulators (IMODs) to selectively absorb and/or reflect light incident thereon using principles of optical interference. IMODs can include an absorber, a reflector that is movable with respect to the absorber, and an optical resonant cavity defined between the absorber and the reflector. The reflector can be moved to two or more different positions, which can change the size of the optical resonant cavity and thereby affect the reflectance of the interferometric modulator. The reflectance spectrums of IMODs can create fairly broad spectral bands which can be shifted across the visible wavelengths to generate different colors. The position of the spectral band can be adjusted by changing the thickness of the optical resonant cavity, i.e., by changing the position of the reflector.

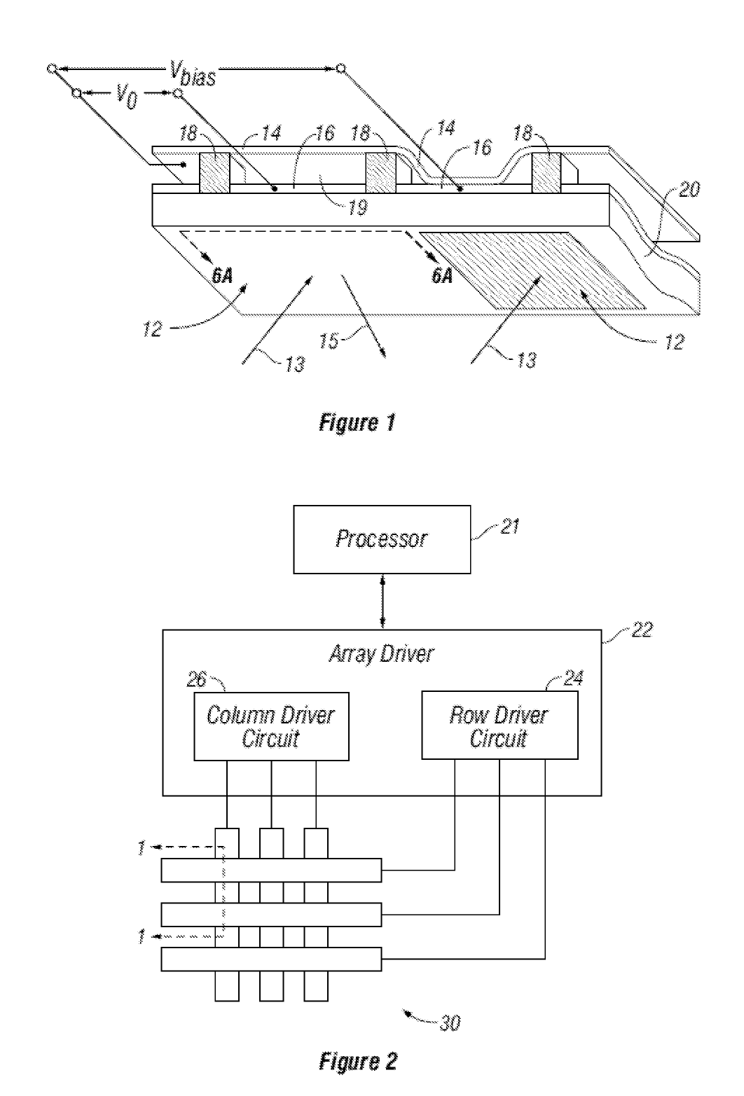

FIG. 1 shows an example of an isometric view depicting two adjacent pixels in a series of pixels of an interferometric modulator (IMOD) display device. The IMOD display device includes one or more interferometric MEMS display elements. In these devices, the pixels of the MEMS display elements can be in either a bright or dark state. In the bright (“relaxed,” “open” or “on”) state, the display element reflects a large portion of incident visible light, e.g., to a user. Conversely, in the dark (“actuated,” “closed” or “off”) state, the display element reflects little incident visible light. In some implementations, the light reflectance properties of the on and off states may be reversed. MEMS pixels can be configured to reflect predominantly at particular wavelengths allowing for a color display in addition to black and white.

The IMOD display device can include a row/column array of IMODs. Each IMOD can include a pair of reflective layers, i.e., a movable reflective layer and a fixed partially reflective layer, positioned at a variable and controllable distance from each other to form an air gap (also referred to as an optical gap or cavity). The movable reflective layer may be moved between at least two positions. In a first position, i.e., a relaxed position, the movable reflective layer can be positioned at a relatively large distance from the fixed partially reflective layer. In a second position, i.e., an actuated position, the movable reflective layer can be positioned more closely to the partially reflective layer. Incident light that reflects from the two layers can interfere constructively or destructively depending on the position of the movable reflective layer, producing either an overall reflective or non-reflective state for each pixel. In some implementations, the IMOD may be in a reflective state when unactuated, reflecting light within the visible spectrum, and may be in a dark state when unactuated, reflecting light outside of the visible range (e.g., infrared light). In some other implementations, however, an IMOD may be in a dark state when unactuated, and in a reflective state when actuated. In some implementations, the introduction of an applied voltage can drive the pixels to change states. In some other implementations, an applied charge can drive the pixels to change states.

The depicted portion of the pixel array in FIG. 1 includes two adjacent interferometric modulators 12. In the IMOD 12 on the left (as illustrated), a movable reflective layer 14 is illustrated in a relaxed position at a predetermined distance from an optical stack 16, which includes a partially reflective layer. The voltage V₀ applied across the IMOD 12 on the left is insufficient to cause actuation of the movable reflective layer 14. In the IMOD 12 on the right, the movable reflective layer 14 is illustrated in an actuated position near or adjacent the optical stack 16. The voltage V_{bias} applied across the IMOD 12 on the right is sufficient to maintain the movable reflective layer 14 in the actuated position.

In FIG. 1, the reflective properties of pixels 12 are generally illustrated with arrows 13 indicating light incident upon the pixels 12, and light 15 reflecting from the pixel 12 on the left. Although not illustrated in detail, it will be understood by one having ordinary skill in the art that most of the light 13 incident upon the pixels 12 will be transmitted through the transparent substrate 20, toward the optical stack 16. A portion of the light incident upon the optical stack 16 will be transmitted through the partially reflective layer of the optical stack 16, and a portion will be reflected back through the transparent substrate 20. The portion of light 13 that is transmitted through the optical stack 16 will be reflected at the movable reflective layer 14, back toward (and through) the transparent substrate 20. Interference (constructive or destructive) between the light reflected from the partially reflective layer of the optical stack 16 and the light reflected from the movable reflective layer 14 will determine the wavelength(s) of light 15 reflected from the pixel 12.

The optical stack 16 can include a single layer or several layers. The layer(s) can include one or more of an electrode layer, a partially reflective and partially transmissive layer and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals, e.g., chromium (Cr), semiconductors, and dielectrics. The partially reflective layer can be formed of one or more layers of materials, and each of the layers can be formed of a single material or a combination of materials. In some implementations, the optical stack 16 can include a single semi-transparent thickness of metal or semiconductor which serves as both an optical absorber and conductor, while different, more conductive layers or portions (e.g., of the optical stack 16 or of other structures of the IMOD) can serve to bus signals between IMOD pixels. The optical stack 16 also can include one or more insulating or dielectric layers covering one or more conductive layers or a conductive/absorptive layer.

In some implementations, the layer(s) of the optical stack 16 can be patterned into parallel strips, and may form row electrodes in a display device as described further below. As will be understood by one having skill in the art, the term “patterned” is used herein to refer to masking as well as etching processes. In some implementations, a highly conductive and reflective material, such as aluminum (Al), may be used for the movable reflective layer 14, and these strips may form column electrodes in a display device. The movable reflective layer 14 may be formed as a series of parallel strips of a deposited metal layer or layers (orthogonal to the row electrodes of the optical stack 16) to form columns deposited on top of posts 18 and an intervening sacrificial material deposited between the posts 18. When the sacrificial material is etched away, a defined gap 19, or optical cavity, can be formed between the movable reflective layer 14 and the optical stack 16. In some implementations, the spacing between posts 18 can be approximately 1-1000 μm, while the gap 19 can be less than 10,000 Angstroms (Å).

In some implementations, each pixel of the IMOD, whether in the actuated or relaxed state, is essentially a capacitor formed by the fixed and moving reflective layers. When no voltage is applied, the movable reflective layer 14 remains in a mechanically relaxed state, as illustrated by the pixel 12 on the left in FIG. 1, with the gap 19 between the movable reflective layer 14 and optical stack 16. However, when a potential difference, e.g., voltage, is applied to at least one of a selected row and column, the capacitor formed at the intersection of the row and column electrodes at the corresponding pixel becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated pixel 12 on the right in FIG. 1. The behavior is the same regardless of the polarity of the applied potential difference. Though a series of pixels in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

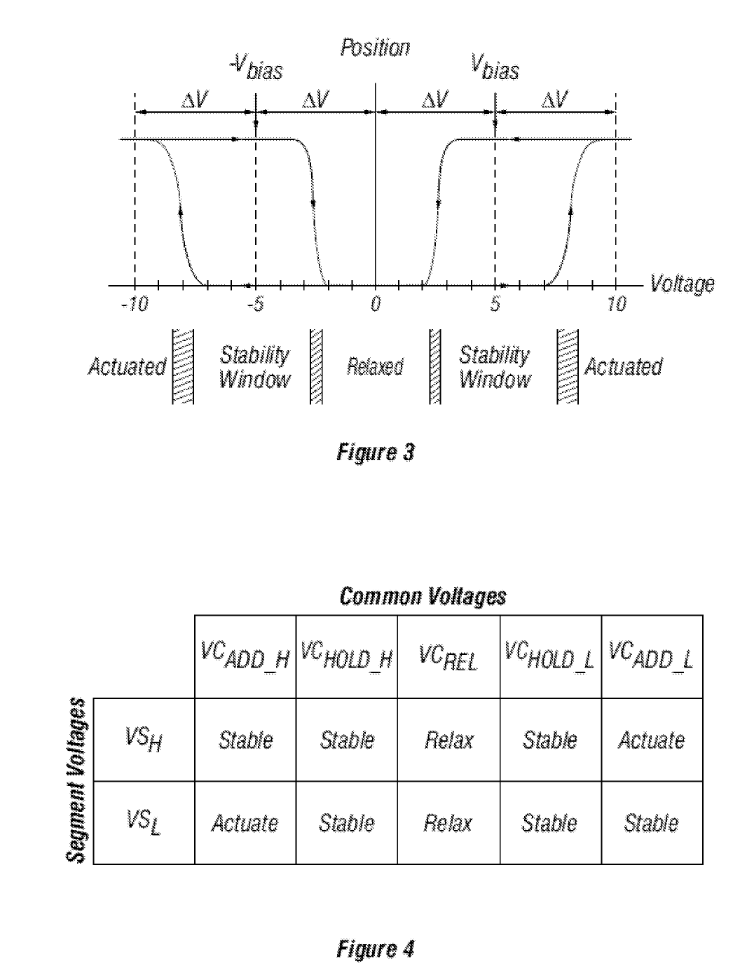

FIG. 2 shows an example of a system block diagram illustrating an electronic device incorporating a 3×3 interferometric modulator display. The electronic device includes a processor 21 that may be configured to execute one or more software modules. In addition to executing an operating system, the processor 21 may be configured to execute one or more software applications, including a web browser, a telephone application, an email program, or any other software application.

The processor 21 can be configured to communicate with an array driver 22. The array driver 22 can include a row driver circuit 24 and a column driver circuit 26 that provide signals to, e.g., a display array or panel 30. The cross section of the IMOD display device illustrated in FIG. 1 is shown by the lines 1-1 in FIG. 2. Although FIG. 2 illustrates a 3×3 array of IMODs for the sake of clarity, the display array 30 may contain a very large number of IMODs, and may have a different number of IMODs in rows than in columns, and vice versa.

FIG. 3 shows an example of a diagram illustrating a movable reflective layer position versus applied voltage for the interferometric modulator of FIG. 1. For MEMS interferometric modulators, the row/column (i.e., common/segment) write procedure may take advantage of a hysteresis property of these devices as illustrated in FIG. 3. An interferometric modulator may use, for example, about a 10-volt potential difference to cause the movable reflective layer, or mirror, to change from the relaxed state to the actuated state. When the voltage is reduced from that value, the movable reflective layer maintains its state as the voltage drops back below, in this example, 10 volts, however, the movable reflective layer does not relax completely until the voltage drops below 2 volts. Thus, a range of voltage, approximately 3 to 7 volts, as shown in FIG. 3, exists where there is a window of applied voltage within which the device is stable in either the relaxed or actuated state. This is referred to herein as the “hysteresis window” or “stability window.” For a display array 30 having the hysteresis characteristics of FIG. 3, the row/column write procedure can be designed to address one or more rows at a time, such that during the addressing of a given row, pixels in the addressed row that are to be actuated are exposed to a voltage difference of about, in this example, 10 volts, and pixels that are to be relaxed are exposed to a voltage difference of near zero volts. After addressing, the pixels are exposed to a steady state or bias voltage difference of approximately, in this example, 5 volts such that they remain in the previous strobing state. In this example, after being addressed, each pixel sees a potential difference within the “stability window” of about 3-7 volts. This hysteresis property feature enables the pixel design, such as the one illustrated in FIG. 1, to remain stable in either an actuated or relaxed pre-existing state under the same applied voltage conditions. Since each IMOD pixel, whether in the actuated or relaxed state, is essentially a capacitor formed by the fixed and moving reflective layers, this stable state can be held at a steady voltage within the hysteresis window without substantially consuming or losing power. Moreover, essentially little or no current flows into the IMOD pixel if the applied voltage potential remains substantially fixed.

In some implementations, a frame of an image may be created by applying data signals in the form of “segment” voltages along the set of column electrodes, in accordance with the desired change (if any) to the state of the pixels in a given row. Each row of the array can be addressed in turn, such that the frame is written one row at a time. To write the desired data to the pixels in a first row, segment voltages corresponding to the desired state of the pixels in the first row can be applied on the column electrodes, and a first row pulse in the form of a specific “common” voltage or signal can be applied to the first row electrode. The set of segment voltages can then be changed to correspond to the desired change (if any) to the state of the pixels in the second row, and a second common voltage can be applied to the second row electrode. In some implementations, the pixels in the first row are unaffected by the change in the segment voltages applied along the column electrodes, and remain in the state they were set to during the first common voltage row pulse. This process may be repeated for the entire series of rows, or alternatively, columns, in a sequential fashion to produce the image frame. The frames can be refreshed and/or updated with new image data by continually repeating this process at some desired number of frames per second.

The combination of segment and common signals applied across each pixel (that is, the potential difference across each pixel) determines the resulting state of each pixel. FIG. 4 shows an example of a table illustrating various states of an interferometric modulator when various common and segment voltages are applied. As will be readily understood by one having ordinary skill in the art, the “segment” voltages can be applied to either the column electrodes or the row electrodes, and the “common” voltages can be applied to the other of the column electrodes or the row electrodes.

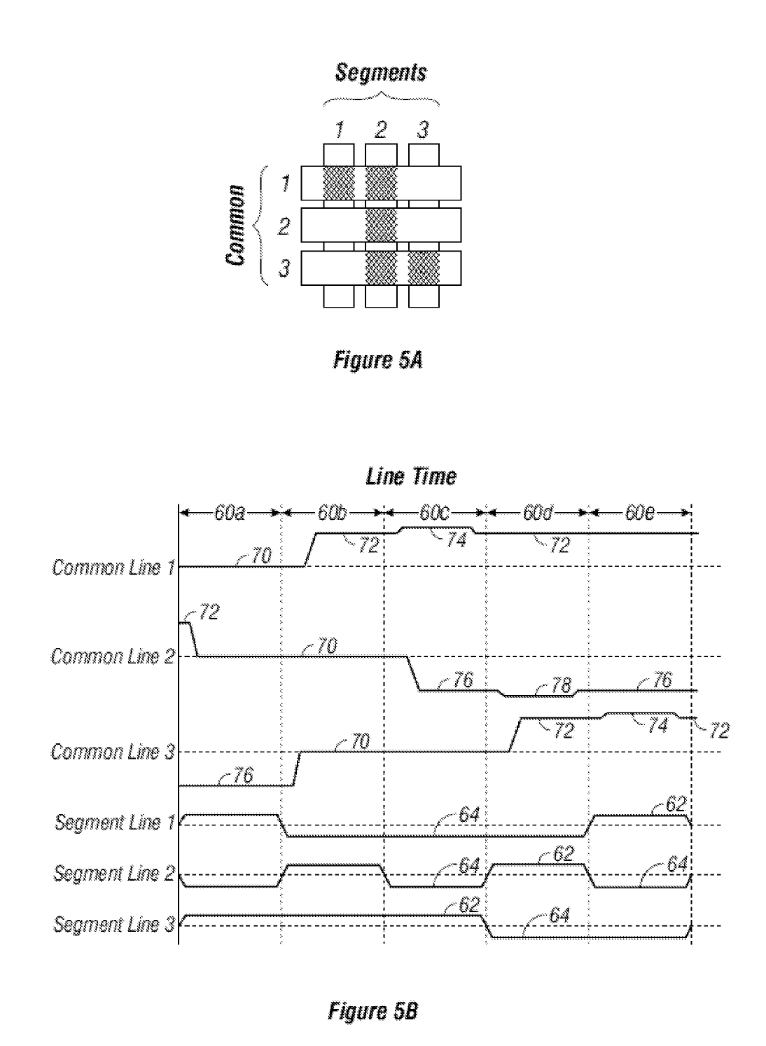

As illustrated in FIG. 4 (as well as in the timing diagram shown in FIG. 5B), when a release voltage VC_{REL} is applied along a common line, all interferometric modulator elements along the common line will be placed in a relaxed state, alternatively referred to as a released or unactuated state, regardless of the voltage applied along the segment lines, i.e., high segment voltage VS_{H} and low segment voltage VS_{L}. In particular, when the release voltage VC_{REL} is applied along a common line, the potential voltage across the modulator (alternatively referred to as a pixel voltage) is within the relaxation window (see FIG. 3, also referred to as a release window) both when the high segment voltage VS_{H} and the low segment voltage VS_{L} are applied along the corresponding segment line for that pixel.

When a hold voltage is applied on a common line, such as a high hold voltage VC_{HOLD}_{_{—}}_{H} or a low hold voltage VC_{HOLD}_{_{—}}_{L}, the state of the interferometric modulator will remain constant. For example, a relaxed IMOD will remain in a relaxed position, and an actuated IMOD will remain in an actuated position. The hold voltages can be selected such that the pixel voltage will remain within a stability window both when the high segment voltage VS_{H} and the low segment voltage VS_{L} are applied along the corresponding segment line. Thus, the segment voltage swing, i.e., the difference between the high VS_{H} and low segment voltage VS_{L}, is less than the width of either the positive or the negative stability window.

When an addressing, or actuation, voltage is applied on a common line, such as a high addressing voltage VC_{ADD}_{_{—}}_{H} or a low addressing voltage VC_{ADD}_{_{—}}_{L}, data can be selectively written to the modulators along that line by application of segment voltages along the respective segment lines. The segment voltages may be selected such that actuation is dependent upon the segment voltage applied. When an addressing voltage is applied along a common line, application of one segment voltage will result in a pixel voltage within a stability window, causing the pixel to remain unactuated. In contrast, application of the other segment voltage will result in a pixel voltage beyond the stability window, resulting in actuation of the pixel. The particular segment voltage which causes actuation can vary depending upon which addressing voltage is used. In some implementations, when the high addressing voltage VC_{ADD}_{_{—}}_{H} is applied along the common line, application of the high segment voltage VS_{H} can cause a modulator to remain in its current position, while application of the low segment voltage VS_{L} can cause actuation of the modulator. As a corollary, the effect of the segment voltages can be the opposite when a low addressing voltage VC_{ADD}_{_{—}}_{L} is applied, with high segment voltage VS_{H} causing actuation of the modulator, and low segment voltage VS_{L} having no effect (i.e., remaining stable) on the state of the modulator.

In some implementations, hold voltages, address voltages, and segment voltages may be used which produce the same polarity potential difference across the modulators. In some other implementations, signals can be used which alternate the polarity of the potential difference of the modulators. Alternation of the polarity across the modulators (that is, alternation of the polarity of write procedures) may reduce or inhibit charge accumulation which could occur after repeated write operations of a single polarity.

FIG. 5A shows an example of a diagram illustrating a frame of display data in the 3×3 interferometric modulator display of FIG. 2. FIG. 5B shows an example of a timing diagram for common and segment signals that may be used to write the frame of display data illustrated in FIG. 5A. The signals can be applied to the, e.g., 3×3 array of FIG. 2, which will ultimately result in the line time 60e display arrangement illustrated in FIG. 5B. The actuated modulators in FIG. 5A are in a dark-state, i.e., where a substantial portion of the reflected light is outside of the visible spectrum so as to result in a dark appearance to, e.g., a viewer. Prior to writing the frame illustrated in FIG. 5A, the pixels can be in any state, but the write procedure illustrated in the timing diagram of FIG. 5B presumes that each modulator has been released and resides in an unactuated state before the first line time 60a.

During the first line time 60a: a release voltage 70 is applied on common line 1; the voltage applied on common line 2 begins at a high hold voltage 72 and moves to a release voltage 70; and a low hold voltage 76 is applied along common line 3. Thus, the modulators (common 1, segment 1), (1,2) and (1,3) along common line 1 remain in a relaxed, or unactuated, state for the duration of the first line time 60a, the modulators (2,1), (2,2) and (2,3) along common line 2 will move to a relaxed state, and the modulators (3,1), (3,2) and (3,3) along common line 3 will remain in their previous state. With reference to FIG. 4, the segment voltages applied along segment lines 1, 2 and 3 will have no effect on the state of the interferometric modulators, as none of common lines 1, 2 or 3 are being exposed to voltage levels causing actuation during line time 60a (i.e., VC_{REL}—relax and VC_{HOLD}_{_{—}}_{L}—stable).

During the second line time 60b, the voltage on common line 1 moves to a high hold voltage 72, and all modulators along common line 1 remain in a relaxed state regardless of the segment voltage applied because no addressing, or actuation, voltage was applied on the common line 1. The modulators along common line 2 remain in a relaxed state due to the application of the release voltage 70, and the modulators (3,1), (3,2) and (3,3) along common line 3 will relax when the voltage along common line 3 moves to a release voltage 70.

During the third line time 60c, common line 1 is addressed by applying a high address voltage 74 on common line 1. Because a low segment voltage 64 is applied along segment lines 1 and 2 during the application of this address voltage, the pixel voltage across modulators (1,1) and (1,2) is greater than the high end of the positive stability window (i.e., the voltage differential exceeded a predefined threshold) of the modulators, and the modulators (1,1) and (1,2) are actuated. Conversely, because a high segment voltage 62 is applied along segment line 3, the pixel voltage across modulator (1,3) is less than that of modulators (1,1) and (1,2), and remains within the positive stability window of the modulator; modulator (1,3) thus remains relaxed. Also during line time 60c, the voltage along common line 2 decreases to a low hold voltage 76, and the voltage along common line 3 remains at a release voltage 70, leaving the modulators along common lines 2 and 3 in a relaxed position.

During the fourth line time 60d, the voltage on common line 1 returns to a high hold voltage 72, leaving the modulators along common line 1 in their respective addressed states. The voltage on common line 2 is decreased to a low address voltage 78. Because a high segment voltage 62 is applied along segment line 2, the pixel voltage across modulator (2,2) is below the lower end of the negative stability window of the modulator, causing the modulator (2,2) to actuate. Conversely, because a low segment voltage 64 is applied along segment lines 1 and 3, the modulators (2,1) and (2,3) remain in a relaxed position. The voltage on common line 3 increases to a high hold voltage 72, leaving the modulators along common line 3 in a relaxed state.

Finally, during the fifth line time 60e, the voltage on common line 1 remains at high hold voltage 72, and the voltage on common line 2 remains at a low hold voltage 76, leaving the modulators along common lines 1 and 2 in their respective addressed states. The voltage on common line 3 increases to a high address voltage 74 to address the modulators along common line 3. As a low segment voltage 64 is applied on segment lines 2 and 3, the modulators (3,2) and (3,3) actuate, while the high segment voltage 62 applied along segment line 1 causes modulator (3,1) to remain in a relaxed position. Thus, at the end of the fifth line time 60e, the 3×3 pixel array is in the state shown in FIG. 5A, and will remain in that state as long as the hold voltages are applied along the common lines, regardless of variations in the segment voltage which may occur when modulators along other common lines (not shown) are being addressed.

In the timing diagram of FIG. 5B, a given write procedure (i.e., line times 60a-60e) can include the use of either high hold and address voltages, or low hold and address voltages. Once the write procedure has been completed for a given common line (and the common voltage is set to the hold voltage having the same polarity as the actuation voltage), the pixel voltage remains within a given stability window, and does not pass through the relaxation window until a release voltage is applied on that common line. Furthermore, as each modulator is released as part of the write procedure prior to addressing the modulator, the actuation time of a modulator, rather than the release time, may determine the line time. Specifically, in implementations in which the release time of a modulator is greater than the actuation time, the release voltage may be applied for longer than a single line time, as depicted in FIG. 5B. In some other implementations, voltages applied along common lines or segment lines may vary to account for variations in the actuation and release voltages of different modulators, such as modulators of different colors.

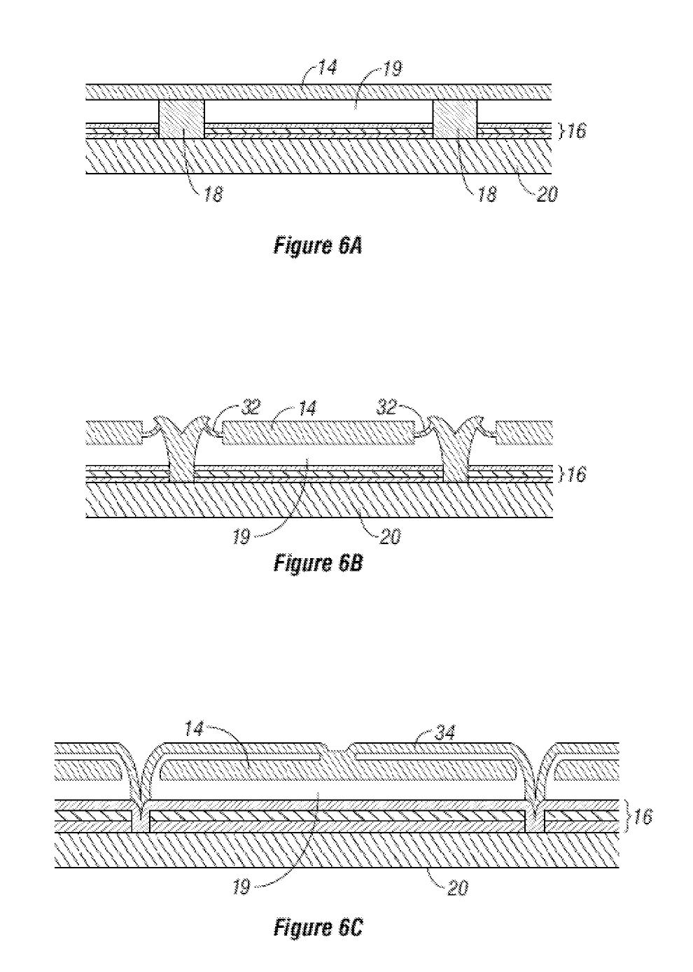

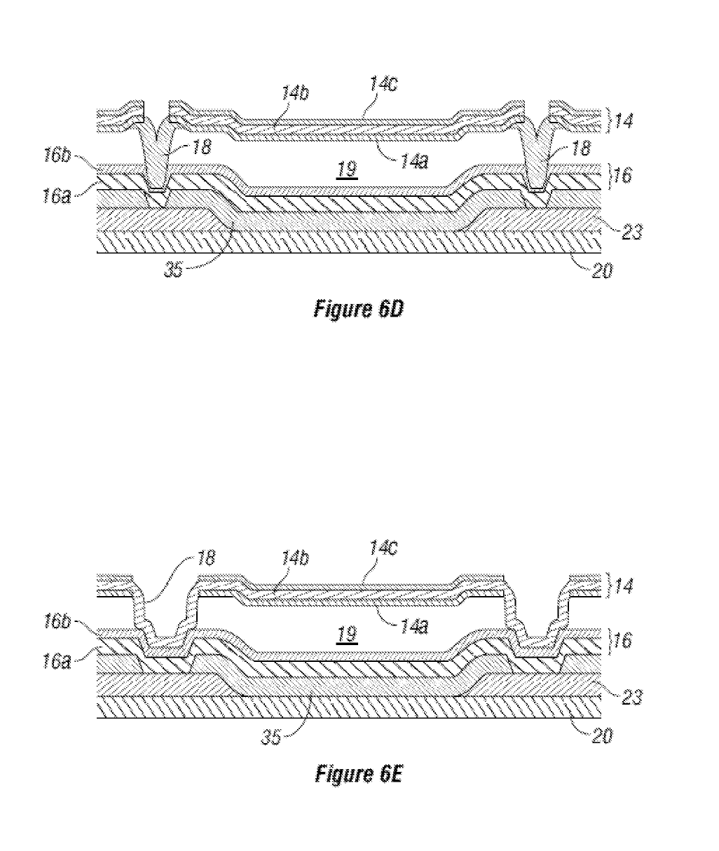

The details of the structure of interferometric modulators that operate in accordance with the principles set forth above may vary widely. For example, FIGS. 6A-6E show examples of cross-sections of varying implementations of interferometric modulators, including the movable reflective layer 14 and its supporting structures. FIG. 6A shows an example of a partial cross-section of the interferometric modulator display of FIG. 1, where a strip of metal material, i.e., the movable reflective layer 14 is deposited on supports 18 extending orthogonally from the substrate 20. In FIG. 6B, the movable reflective layer 14 of each IMOD is generally square or rectangular in shape and attached to supports at or near the corners, on tethers 32. In FIG. 6C, the movable reflective layer 14 is generally square or rectangular in shape and suspended from a deformable layer 34, which may include a flexible metal. The deformable layer 34 can connect, directly or indirectly, to the substrate 20 around the perimeter of the movable reflective layer 14. These connections are herein referred to as support posts. The implementation shown in FIG. 6C has additional benefits deriving from the decoupling of the optical functions of the movable reflective layer 14 from its mechanical functions, which are carried out by the deformable layer 34. This decoupling allows the structural design and materials used for the reflective layer 14 and those used for the deformable layer 34 to be optimized independently of one another.

FIG. 6D shows another example of an IMOD, where the movable reflective layer 14 includes a reflective sub-layer 14a. The movable reflective layer 14 rests on a support structure, such as support posts 18. The support posts 18 provide separation of the movable reflective layer 14 from the lower stationary electrode (i.e., part of the optical stack 16 in the illustrated IMOD) so that a gap 19 is formed between the movable reflective layer 14 and the optical stack 16, for example when the movable reflective layer 14 is in a relaxed position. The movable reflective layer 14 also can include a conductive layer 14c, which may be configured to serve as an electrode, and a support layer 14b. In this example, the conductive layer 14c is disposed on one side of the support layer 14b, distal from the substrate 20, and the reflective sub-layer 14a is disposed on the other side of the support layer 14b, proximal to the substrate 20. In some implementations, the reflective sub-layer 14a can be conductive and can be disposed between the support layer 14b and the optical stack 16. The support layer 14b can include one or more layers of a dielectric material, for example, silicon oxynitride (SiON) or silicon dioxide (SiO₂). In some implementations, the support layer 14b can be a stack of layers, such as, for example, a SiO₂/SiON/SiO₂ tri-layer stack. Either or both of the reflective sub-layer 14a and the conductive layer 14c can include, e.g., an aluminum (Al) alloy with about 0.5% copper (Cu), or another reflective metallic material. Employing conductive layers 14a, 14c above and below the dielectric support layer 14b can balance stresses and provide enhanced conduction. In some implementations, the reflective sub-layer 14a and the conductive layer 14c can be formed of different materials for a variety of design purposes, such as achieving specific stress profiles within the movable reflective layer 14.

As illustrated in FIG. 6D, some implementations also can include a black mask structure 23. The black mask structure 23 can be formed in optically inactive regions (e.g., between pixels or under posts 18) to absorb ambient or stray light. The black mask structure 23 also can improve the optical properties of a display device by inhibiting light from being reflected from or transmitted through inactive portions of the display, thereby increasing the contrast ratio. Additionally, the black mask structure 23 can be conductive and be configured to function as an electrical bussing layer. In some implementations, the row electrodes can be connected to the black mask structure 23 to reduce the resistance of the connected row electrode. The black mask structure 23 can be formed using a variety of methods, including deposition and patterning techniques. The black mask structure 23 can include one or more layers. For example, in some implementations, the black mask structure 23 includes a molybdenum-chromium (MoCr) layer that serves as an optical absorber, a SiO₂ layer, and an aluminum alloy that serves as a reflector and a bussing layer, with a thickness in the range of about 30-80 Å, 500-1000 Å, and 500-6000 Å, respectively. The one or more layers can be patterned using a variety of techniques, including photolithography and dry etching, including, for example, carbon tetrafluoromethane (CFO and/or oxygen (O₂) for the MoCr and SiO₂ layers and chlorine (Cl₂) and/or boron trichloride (BCl₃) for the aluminum alloy layer. In some implementations, the black mask 23 can be an etalon or interferometric stack structure. In such interferometric stack black mask structures 23, the conductive absorbers can be used to transmit or bus signals between lower, stationary electrodes in the optical stack 16 of each row or column. In some implementations, a spacer layer 35 can serve to generally electrically isolate the absorber layer 16a from the conductive layers in the black mask 23.

FIG. 6E shows another example of an IMOD, where the movable reflective layer 14 is self-supporting. In contrast with FIG. 6D, the implementation of FIG. 6E does not include support posts 18. Instead, the movable reflective layer 14 contacts the underlying optical stack 16 at multiple locations, and the curvature of the movable reflective layer 14 provides sufficient support that the movable reflective layer 14 returns to the unactuated position of FIG. 6E when the voltage across the interferometric modulator is insufficient to cause actuation. The optical stack 16, which may contain a plurality of several different layers, is shown here for clarity including an optical absorber 16a, and a dielectric 16b. In some implementations, the optical absorber 16a may serve both as a fixed electrode and as a partially reflective layer.

In implementations such as those shown in FIGS. 6A-6E, the IMODs function as direct-view devices, in which images are viewed from the front side of the transparent substrate 20, i.e., the side opposite to that upon which the modulator is arranged. In these implementations, the back portions of the device (that is, any portion of the display device behind the movable reflective layer 14, including, for example, the deformable layer 34 illustrated in FIG. 6C) can be configured and operated upon without impacting or negatively affecting the image quality of the display device, because the reflective layer 14 optically shields those portions of the device. For example, in some implementations a bus structure (not illustrated) can be included behind the movable reflective layer 14 which provides the ability to separate the optical properties of the modulator from the electromechanical properties of the modulator, such as voltage addressing and the movements that result from such addressing. Additionally, the implementations of FIGS. 6A-6E can simplify processing, such as patterning.

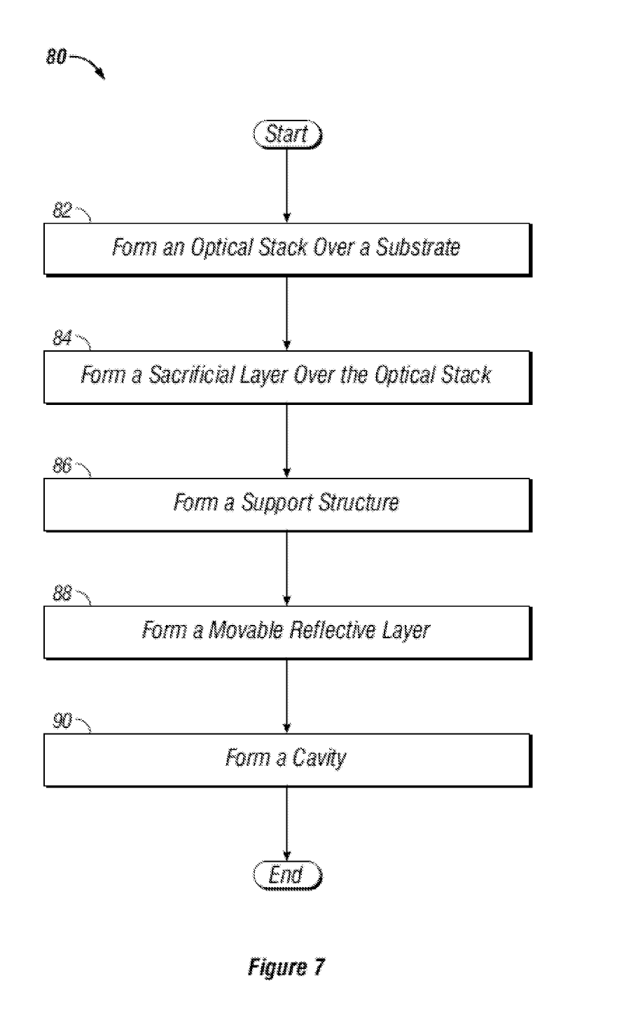

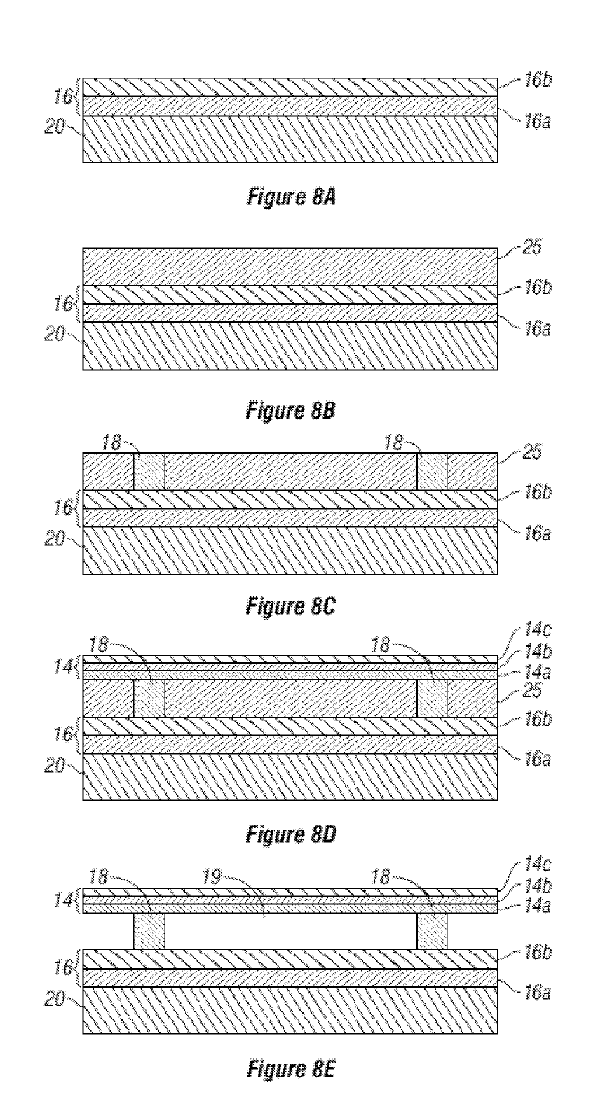

FIG. 7 shows an example of a flow diagram illustrating a manufacturing process 80 for an interferometric modulator, and FIGS. 8A-8E show examples of cross-sectional schematic illustrations of corresponding stages of such a manufacturing process 80. In some implementations, the manufacturing process 80 can be implemented to manufacture, e.g., interferometric modulators of the general type illustrated in FIGS. 1 and 6, in addition to other blocks not shown in FIG. 7. With reference to FIGS. 1, 6 and 7, the process 80 begins at block 82 with the formation of the optical stack 16 over the substrate 20. FIG. 8A illustrates such an optical stack 16 formed over the substrate 20. The substrate 20 may be a transparent substrate such as glass or plastic, it may be flexible or relatively stiff and unbending, and may have been subjected to prior preparation processes, e.g., cleaning, to facilitate efficient formation of the optical stack 16. As discussed above, the optical stack 16 can be electrically conductive, partially transparent and partially reflective and may be fabricated, for example, by depositing one or more layers having the desired properties onto the transparent substrate 20. In FIG. 8A, the optical stack 16 includes a multilayer structure having sub-layers 16a and 16b, although more or fewer sub-layers may be included in some implementations. In some implementations, one of the sub-layers 16a, 16b can be configured with both optically absorptive and conductive properties, such as the combined conductor/absorber sub-layer 16a. Additionally, one or more of the sub-layers 16a, 16b can be patterned into parallel strips, and may form row electrodes in a display device. Such patterning can be performed by a masking and etching process or another suitable process known in the art. In some implementations, one of the sub-layers 16a, 16b can be an insulating or dielectric layer, such as sub-layer 16b that is deposited over one or more metal layers (e.g., one or more reflective and/or conductive layers). In addition, the optical stack 16 can be patterned into individual and parallel strips that form the rows of the display.

The process 80 continues at block 84 with the formation of a sacrificial layer 25 over the optical stack 16. The sacrificial layer 25 is later removed (e.g., at block 90) to form the cavity 19 and thus the sacrificial layer 25 is not shown in the resulting interferometric modulators 12 illustrated in FIG. 1. FIG. 8B illustrates a partially fabricated device including a sacrificial layer 25 formed over the optical stack 16. The formation of the sacrificial layer 25 over the optical stack 16 may include deposition of a xenon difluoride (XeF₂)-etchable material such as molybdenum (Mo) or amorphous silicon (Si), in a thickness selected to provide, after subsequent removal, a gap or cavity 19 (see also FIGS. 1 and 8E) having a desired design size. Deposition of the sacrificial material may be carried out using deposition techniques such as physical vapor deposition (PVD, e.g., sputtering), plasma-enhanced chemical vapor deposition (PECVD), thermal chemical vapor deposition (thermal CVD), or spin-coating.

The process 80 continues at block 86 with the formation of a support structure e.g., a post 18 as illustrated in FIGS. 1, 6 and 8C. The formation of the post 18 may include patterning the sacrificial layer 25 to form a support structure aperture, then depositing a material (e.g., a polymer or an inorganic material, e.g., silicon oxide) into the aperture to form the post 18, using a deposition method such as PVD, PECVD, thermal CVD, or spin-coating. In some implementations, the support structure aperture formed in the sacrificial layer can extend through both the sacrificial layer 25 and the optical stack 16 to the underlying substrate 20, so that the lower end of the post 18 contacts the substrate 20 as illustrated in FIG. 6A. Alternatively, as depicted in FIG. 8C, the aperture formed in the sacrificial layer 25 can extend through the sacrificial layer 25, but not through the optical stack 16. For example, FIG. 8E illustrates the lower ends of the support posts 18 in contact with an upper surface of the optical stack 16. The post 18, or other support structures, may be formed by depositing a layer of support structure material over the sacrificial layer 25 and patterning portions of the support structure material located away from apertures in the sacrificial layer 25. The support structures may be located within the apertures, as illustrated in FIG. 8C, but also can, at least partially, extend over a portion of the sacrificial layer 25. As noted above, the patterning of the sacrificial layer 25 and/or the support posts 18 can be performed by a patterning and etching process, but also may be performed by alternative etching methods.

The process 80 continues at block 88 with the formation of a movable reflective layer or membrane such as the movable reflective layer 14 illustrated in FIGS. 1, 6 and 8D. The movable reflective layer 14 may be formed by employing one or more deposition steps, e.g., reflective layer (e.g., aluminum, aluminum alloy) deposition, along with one or more patterning, masking, and/or etching steps. The movable reflective layer 14 can be electrically conductive, and referred to as an electrically conductive layer. In some implementations, the movable reflective layer 14 may include a plurality of sub-layers 14a, 14b, 14c as shown in FIG. 8D. In some implementations, one or more of the sub-layers, such as sub-layers 14a, 14c, may include highly reflective sub-layers selected for their optical properties, and another sub-layer 14b may include a mechanical sub-layer selected for its mechanical properties. Since the sacrificial layer 25 is still present in the partially fabricated interferometric modulator formed at block 88, the movable reflective layer 14 is typically not movable at this stage. A partially fabricated IMOD that contains a sacrificial layer 25 also may be referred to herein as an “unreleased” IMOD. As described above in connection with FIG. 1, the movable reflective layer 14 can be patterned into individual and parallel strips that form the columns of the display.

The process 80 continues at block 90 with the formation of a cavity, e.g., cavity 19 as illustrated in FIGS. 1, 6 and 8E. The cavity 19 may be formed by exposing the sacrificial material 25 (deposited at block 84) to an etchant. For example, an etchable sacrificial material such as Mo or amorphous Si may be removed by dry chemical etching, e.g., by exposing the sacrificial layer 25 to a gaseous or vaporous etchant, such as vapors derived from solid XeF₂ for a period of time that is effective to remove the desired amount of material, typically selectively removed relative to the structures surrounding the cavity 19. Other etching methods, e.g. wet etching and/or plasma etching, also may be used. Since the sacrificial layer 25 is removed during block 90, the movable reflective layer 14 is typically movable after this stage. After removal of the sacrificial material 25, the resulting fully or partially fabricated IMOD may be referred to herein as a “released” IMOD.

There may be issues and challenges related to the removal of the sacrificial material during the fabrication of an EMS device with an etchant, however. Liquid etchants, such as an acid or solvent in liquid form, may not be able to be used in some implementations. Due to the high surface tension of liquids, an air gap being fabricated might collapse, causing material layers to come into contact with one another when removing the liquid. This could render the EMS device inoperable due to the material layers not separating. Even if the air gap does not collapse, removing the liquid from the air gap, such as by evaporation, also may be difficult.

Gaseous or vaporous etchants, such as XeF₂, may be toxic, making them difficult and/or expensive to handle. Further, after removing the sacrificial material with XeF₂, residues (thought to be carbon-based compounds) on the material layers may remain that contribute to stiction, i.e., static friction. Stiction may cause the material layers of the EMS device to stick together after collapse of the air gap during the device operation, rendering the device inoperable. Thus, in some implementations, it may be useful to form air gaps partially or completely without the use of etchable sacrificial materials and etchants, such as XeF₂. This may be done using a support structure and a liner material, as described further below.

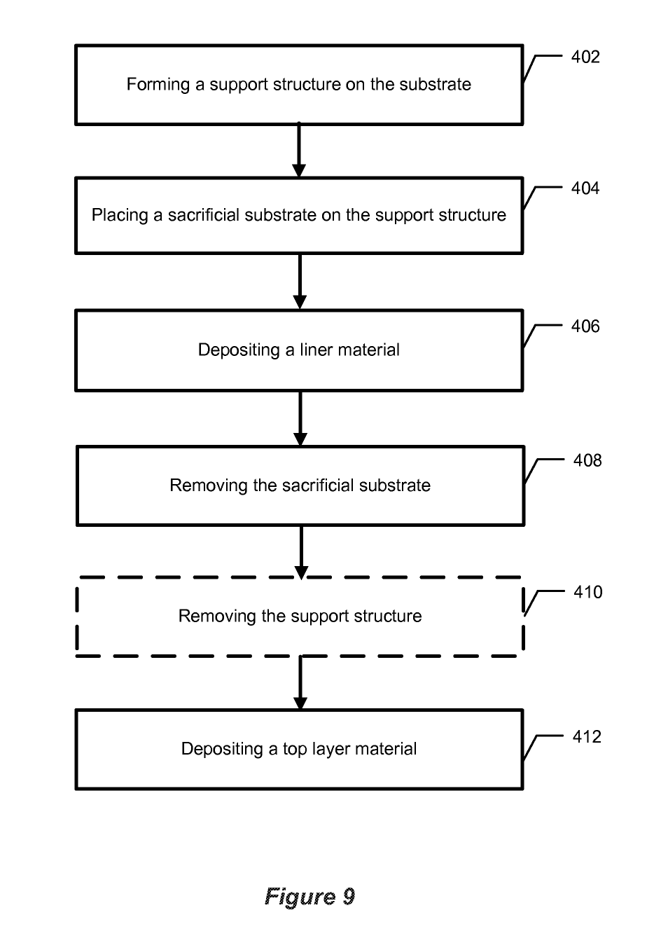

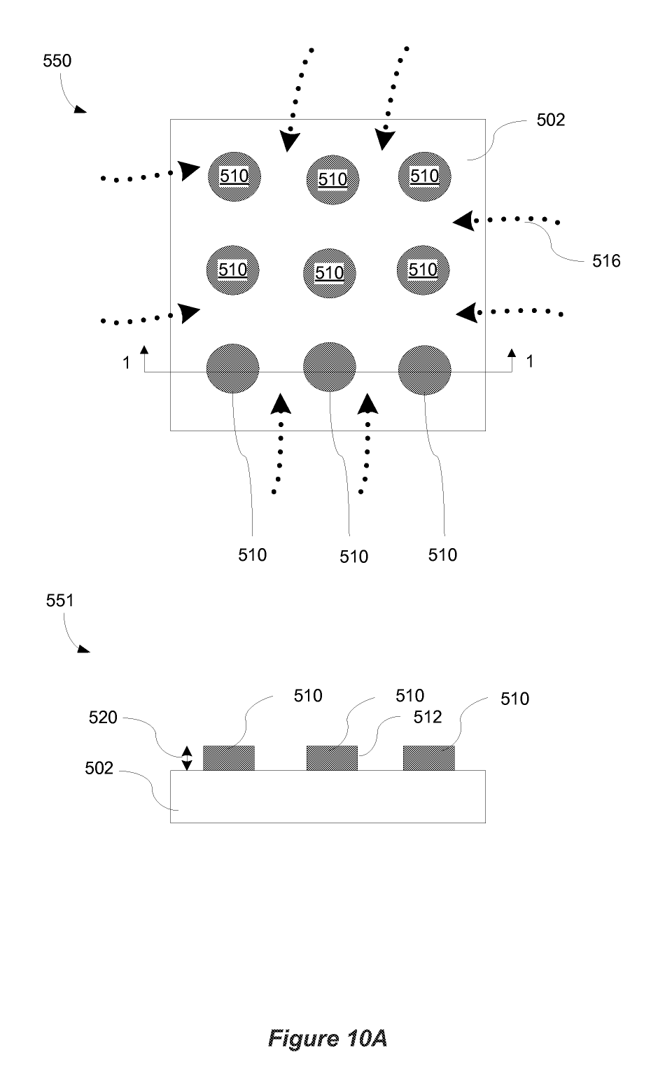

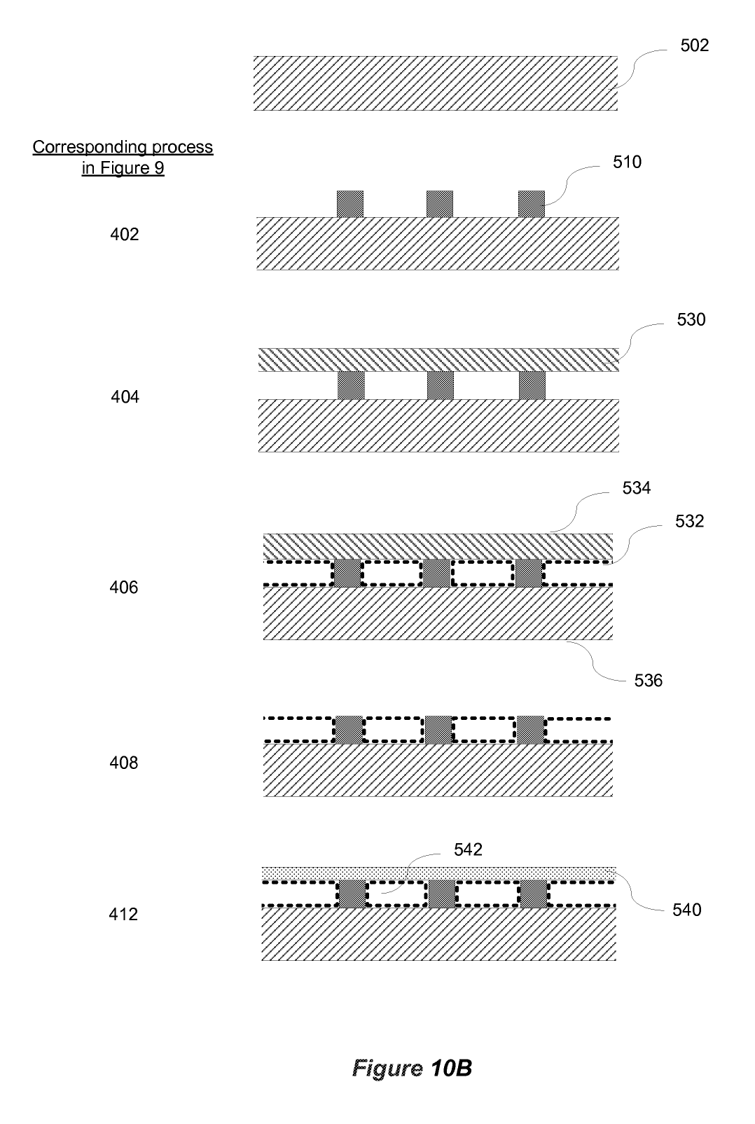

FIG. 9 shows an example of a flow diagram illustrating a method of forming an air gap of an EMS device. FIG. 10A shows an example of a portion of a substrate and the materials deposited on the substrate, while FIG. 10B shows cross-sectional views of the substrate at various stages corresponding to the flow diagram of FIG. 9. In some implementations, an air gap of an EMS device is formed without removing a sacrificial material from between two layers of material. In some implementations, an air gap can be formed in an EMS device without the use of liquids or gasses to remove or dissolve a sacrificial material. Each block of the method of FIG. 9, along with FIGS. 10A and 10B, showing an example of a portion of a substrate and the material layers formed in the blocks of the method of FIG. 9, is described below. Note that FIGS. 10A and 10B may not be to scale.

In block 402, a support structure is formed on a surface of a substrate, as shown in FIGS. 10A and 10B. Substrate 502 may include a number of different materials. For example, in various implementations, the substrate is a glass, a plastic, a metal, or a semiconductor. In some implementations, the substrate is a stainless steel metal substrate or a silicon substrate. Silicon substrates include both single crystal silicon substrates and polycrystalline silicon substrates. In some implementations, the substrate is a borosilicate glass substrate. The substrate 502 also may include a multilayer stack with a number of different materials layered on one another, all formed on a substrate or together forming a composite substrate. For example, the substrate may include a layer of an optical oxide (i.e., a buffer layer), a layer of molybdenum (Mo), a layer of chromium (Cr), or a layer of an alloy of the two (i.e., an absorber layer), and further layers of optical oxide (e.g., similar or identical to the optical stack for the interferometric modulator described above). The substrate 502 also may include circuit patterns. For example, in interferometric modulators, the substrate 502 may include Mo, Cr, or an alloy of the two configured as circuit patterns. The thickness of the substrate 502 is material dependent. In some implementations, the substrate 502 is at least thick enough to be mechanically rigid (i.e., not flex). For example, a glass substrate may be about 0.7 millimeters thick, and a stainless steel substrate may be about 0.1 millimeters thick. Note that FIGS. 10A and 10B depict a portion of the substrate 502, and that the substrate 502 may be many times larger, in surface area and/or thickness, than the portions shown in FIG. 10A.

With continued reference to block 402 of FIG. 9, the support structure formed on the substrate 502 can include a number of different materials. For example, the support structure may include ceramics and metals. In some implementations, the support structure is an oxide, such as silicon oxide (SiO₂) or aluminum oxide (Al₂O₃). In other implementations, the support structure is a silicon compound, such as silicon nitride (SiN) or silicon oxynitride (SiON). The method used to form the support structure depends on the material used for the support structure and the geometry of the support structure. Many different geometries of the support structure are possible in different implementations and are described herein. Generally, the support structure overlays a portion of the substrate 502, and leaves a portion of the substrate exposed.

In some implementations, as shown in FIGS. 10A and 10B, the support structure includes a plurality of posts 510. The top portion 550 of FIG. 10A depicts a top-down view of the surface of the substrate 502, and the bottom portion 551 of FIG. 10A depicts a cross-sectional view along the direction of the arrows 1-1. In some implementations, the posts may be arranged in other patterns, such as a triangular, a hexagonal, or a rectangular pattern, and the arrangement is not limited to the square pattern shown in FIG. 10A. The posts may be spaced about 25 to 150 micrometers apart from one another. In some implementations, the posts 510 may have different cross-sections, such as triangular, hexagonal, or square cross-sections, and are not limited to the cylindrical cross-section shown in FIG. 10A. In some implementations, the posts are about 2 to 10 micrometers at their largest cross-section (e.g., for the support structure 510 that includes cylindrical posts, the largest cross-section is the diameter of the posts).

The height of the support structure depends on the type of EMS device being fabricated. Height 520 is generally about 100 nanometers to 2 micrometers. For example, in implementations of the method used to fabricate an interferometric modulator, the height 520 is about 100 to 200 nm. As another example, in implementations of the method used to fabricate a capacitive accelerometer, the height 520 is about 1 to 2 micrometers.

In some implementations, the support structure may be formed by depositing a layer of material on the substrate. The material may be deposited on the substrate via physical vapor deposition (PVD), chemical vapor deposition (CVD), or other techniques. In some implementations where a silicon substrate is used, instead of depositing a layer of material on the substrate, the silicon substrate may be heated in an environment including oxygen to form a layer of SiO₂ on the silicon substrate. After depositing or forming the layer of material on the substrate, a photoresist is deposited on the layer of material and patterned. After patterning the photoresist, regions of the layer of material may be removed via etching or other techniques to form the support structure. In other implementations, the support structure is formed by first depositing a photoresist on the substrate. After patterning the photoresist to expose regions of the substrate, the support structure is deposited on these regions of the substrate, and then the remaining photoresist is removed.

In some implementations, the support structure may be formed in the substrate with an embossing method or by otherwise deforming the substrate. Embossing is a method of producing raised or sunken designs or relief in a substrate. In various implementations, embossing may be performed on a metal, glass, or polymer substrate. In embossing, a male or female die with the pattern of the desired support structure is pressed into the substrate. The substrate may be held at an elevated temperature during embossing.

Surfaces of walls 512 of the support structure 510 are a by-product of the method used to form the support structure. Further, the walls 512 are shown as being perpendicular to the surface of the substrate 502 in FIGS. 10A and 10B. In some implementations, the walls may be slanted at an angle with respect to the surface of the substrate or include a curved surface.

Returning to FIG. 9, in block 404, after the support structure 510 is formed on the substrate 502, sacrificial substrate 530 is placed on the support structure 510, as shown in block 404 in FIG. 10B. When the sacrificial substrate 530 is placed on the support structure 510, a surface of the sacrificial substrate is facing and spaced apart from the substrate 502. In some implementations, the surface of the sacrificial substrate facing the substrate is substantially parallel to the substrate. The sacrificial substrate can be a sheet of material that is at least thick enough to be mechanically rigid (i.e., not flex). The sacrificial substrate may include a glass, a plastic, a metal, or a semiconductor. In some implementations, the sacrificial substrate is the same material as the substrate, e.g., a stainless steel metal substrate, a silicon substrate, or a borosilicate glass substrate. The sacrificial substrate material is dependent on the process used to remove the sacrificial substrate in block 408, in some implementations. The sacrificial substrate may be held in place on the support structure using a number of different techniques.

In some implementations, the sacrificial substrate 530 is held in place mechanically. For example, clamps or other devices may apply a force to hold the sacrificial substrate 530 on the support structure 510. In another example, a mass may simply be placed on the sacrificial substrate that holds it on the support structure when the substrate is resting on a flat surface.

In some implementations, the sacrificial substrate 530 is bonded to the support structure 510. For example, a bonding material such as a photoresist, an adhesive material, or a polymer material is first deposited on the sacrificial substrate. Then, the sacrificial substrate is placed on the support structure and the bonding material acts to bond the sacrificial substrate to the support structure. In some implementations, the bonding material is easy to deposit on the sacrificial substrate. In other implementations, the sacrificial substrate itself includes a material that bonds to the support structure. For example, the sacrificial substrate may include a plastic or a glass that bonds to the support structure with the application of pressure, heat, and/or ultraviolet light. The sacrificial substrate also may include a film on a plastic or glass substrate that bonds to the support structure with the application of pressure, heat, and/or ultraviolet light.

Returning to FIG. 9, in block 406, a liner material is deposited on the surface of the substrate 502, the support structure 510, and the sacrificial substrate 530. In some implementations, the liner material is deposited via an atomic layer deposition (ALD) process. The liner material 532 may serve to define an open space or an air gap between the substrate and materials (i.e., a top layer material) that are subsequently deposited on the liner material. ALD, in some implementations, is used to deposit the liner material to help to ensure that the liner material is deposited conformally on all of the surfaces. Further, ALD processes generally produce clean surfaces, free of contaminants and other residues. As discussed above, this is important in avoiding stiction if the air gap collapses during operation of the EMS device. While ALD can deposit the liner material 532 on all of the exposed surfaces of the structure in FIG. 10B (i.e., a top surface 534 of the sacrificial substrate 530 and a bottom surface 536 of the substrate 502), the useful regions in this method are the regions between the sacrificial substrate 530 and the substrate 502 that are separated by the support structure 510. Hence, these are the only regions shown as having the liner material 532 deposited on them in FIG. 10B, 11, and 13B.

ALD is a thin film deposition technique. ALD is usually performed with two different chemicals or precursors. The precursors are sequentially admitted to a reaction chamber where they contact the workpiece (i.e., the surface that is being coated). In the implementation of the support structure shown in FIGS. 10A and 10B, the support structure 510 has an open configuration, allowing the precursors to contact the substrate 502, the support structure 510, and the sacrificial substrate 530 from the sides, as indicated by arrows 516. By exposing the precursors to a surface repeatedly, a thin film (i.e., the liner material) can be deposited.

ALD is a self-limiting process (i.e., the amount of material deposited in each reaction cycle is constant). ALD is similar to a chemical vapor deposition (CVD) process, with the major difference being that the ALD reaction breaks the CVD reaction into two half-reactions, keeping the precursor materials separate during the reaction. By breaking the CVD reaction into two half-reactions, very precise control of the layer growth can be obtained. This, however, also makes the ALD process limited to depositing relatively thin films, as film growth is slow with ALD due to the process of sequentially exposing a surface to the ALD precursors.

In block 406 of FIG. 9, it is useful to deposit enough liner material so that the liner material is thick enough to not break during the remainder of the method, described below. For example, the liner material may be thick enough such that it does not collapse when the sacrificial substrate is removed. The liner material also may be thick enough such that it does not collapse during the deposition of the top layer material. In some implementations, the liner material is about 100 to 10,000 Angstroms thick. In some implementations, the liner material is about 100 to 1,000 Angstroms thick, and in other implementations, about 1,000 to 10,000 Angstroms thick.

ALD can be used to deposit several types of materials, including various oxides, e.g., Al₂O₃, titanium oxide (TiO₂), tin oxide (SnO₂), zinc oxide (ZnO), hafnium oxide (HfO₂), metal nitrides (e.g., titanium nitride (TiN), tantalum nitride (TaN), tungsten nitride (WN), niobium nitride (NbN)), and metals (e.g., ruthenium (Ru), iridium (Ir), platinum (Pt)). In some implementations, the liner material includes Al₂O₃ that is deposited using water and trimethyl aluminum for the precursors. In other implementations, the liner material includes TiO₂ that is deposited using water and titanium tetrachloride or titanium isopropoxide for the precursors.

As noted above, ALD may deposit the liner material on all exposed surfaces, including the top surface 534 of the sacrificial substrate 530 and the bottom surface 536 of the substrate 502. In some implementations, it may be desirable not to deposit the liner material on these surfaces, and possibly other surfaces. For example, if the liner material is deposited on the top surface of the sacrificial substrate, it may be more difficult to remove the sacrificial substrate in block 408 or the liner material on the top surface of the sacrificial substrate may form flakes when removing the sacrificial substrate, contaminating the process equipment. To avoid deposition of the liner material on surfaces where it is not desired, these surfaces may be treated to inhibit liner material deposition. The treatment used for the surfaces depends on the ALD precursors. For example, if one of the precursors is water (as in the Al₂O₃ and TiO₂ ALD precursors described above), making the surface hydrophobic may help to inhibit liner material depositing on that surface. One way in which to make a surface hydrophobic is to form a self-assembled monolayer (SAM) on the surface.

Returning to FIG. 9, in block 408, the sacrificial substrate 530 is removed. Removing the sacrificial substrate 530 exposes the area of the support structure 510 on which the sacrificial substrate was placed as well as portions of the liner material 532 that were deposited onto the sacrificial substrate. The technique used to remove the sacrificial substrate 530 depends on the technique used to hold or bond the sacrificial substrate to the support structure 510. In implementations in which the sacrificial substrate is held on the support structure mechanically, the mechanical mechanism is removed. For example, if the sacrificial substrate is held onto the support structure with a clamp, the clamp is removed, or if the sacrificial substrate in held onto the support structure with a mass, the mass is removed. In implementations in which the sacrificial substrate is bonded to the support structure with a bonding material, the sacrificial substrate is removed by treating the bonding material with a chemical to dissolve or otherwise react with the bonding material (i.e., releasing the bonding material). It can be useful to have the bonding material be relatively easy to release such that the sacrificial substrate can be removed without extensive processing.

In some implementations, the sacrificial substrate is removed by etching the substrate with a chemical etchant (liquid or gaseous) or otherwise dissolving the sacrificial substrate. In these implementations, the sacrificial substrate may be a different material than the substrate so that the chemical etchant attacks the sacrificial substrate and not the substrate or the liner material. For example, the sacrificial substrate could be silicon which is etched by XeF₂ and the substrate could be a borosilicate glass. Also, when the sacrificial substrate is removed by etching or dissolution, the sacrificial substrate may be thin so that it can be etched or dissolved relatively quickly. For example, in some implementations, the sacrificial substrate may be about 0.2 millimeters thick.

In some implementations, the sacrificial substrate is removed via mechanical techniques, such as grinding or polishing the sacrificial substrate. If a mechanical technique is used, however, very precise control is needed to avoid removing and/or otherwise damaging the liner material 532 that was deposited in block 406.

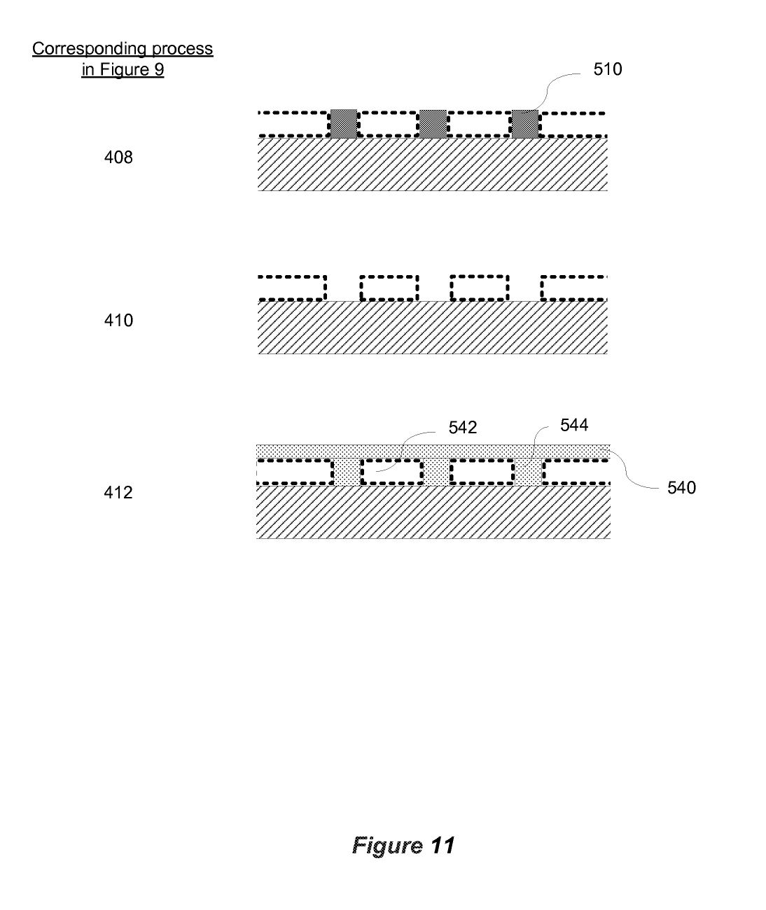

Returning to FIG. 9, in block 410, in some implementations, the support structure 510 is removed following block 408. Removing the support structure is described in more detail below, with reference to FIG. 11. However, in some implementations, the support structure 510 is not removed, and may serve as posts to support a top layer material 540, as illustrated in FIG. 10B.

In block 412, the top layer material 540 is deposited. The top layer material 540 is deposited on the support structure 510 and the liner material 532 that the removal of the sacrificial substrate 530 exposed. The top layer material 540 is separated from the substrate 502 by an open space 542 defined by the liner material. In some implementations, the top layer material is separated from the substrate by about 50 nanometers to 2 micrometers.

The top layer material 540 may include any number of different materials, depending on the EMS device being fabricated. For example, the top layer material may be a metal or a ceramic. In some implementations, top layer material is Al, Ni, SiON, or an oxide such as SiO₂. The top layer material may be deposited with a number of different techniques, depending on the material of the top layer material. In some implementations, the top layer material is deposited with a PVD process or a CVD process. Again, as discussed above, the liner material 532 can be thick enough such that the liner material does not break or otherwise collapse when the top layer material 540 is deposited on it. In some implementations, the top layer material is about 10 to 1,000 nanometers thick, and in some implementations, the top layer material is about 50 nanometers thick. When the top layer material is about 10 to 1,000 nanometers thick, for example, it may be difficult to handle a layer of the top layer material (i.e., a layer of the material by itself, with no supporting structure) and to place the layer on the support structure (e.g., as the sacrificial substrate was placed on the support structure). This is one reason for using the liner material to define an open space or air gap and then depositing the top layer material on the liner material and the support structure.

In some implementations, the top layer material 540 completes the fabrication of an EMS device. For example, in an interferometric modulator, the top layer material can be the mechanical layer that is the last layer deposited. In other implementations, fabrication of the EMS device may continue with further processing and/or further materials deposited on the top layer material.

In some implementations, the EMS device can be fabricated on a sacrificial substrate. Fabricating the EMS device on a sacrificial substrate may include processes similar to those shown in FIG. 9. In such an implementation, the substrate 502 shown in FIGS. 10A and 10B may instead be a sacrificial substrate and the sacrificial substrate 530 may be the substrate. 502, as the sacrificial substrate in this implementation, would be removed in block 408. Similarly, 530, as the substrate, would remain.

As noted above, in some implementations, the support structure 510 may be removed in block 410. FIG. 11 shows an example in which a support structure is removed. That is, FIG. 11 shows cross-sectional views of the substrate at various stages corresponding to the flow diagram of FIG. 9, including block 410 of removing the support structure. Note that FIG. 11 may not be to scale. The material layers in FIG. 11 and the processes used to form them are the same, in some implementations, as those shown in FIG. 10B for blocks 402, 404, 406, and 408.

As shown in FIG. 11, the support structure 510 is removed in block 410 of FIG. 9. The support structure may be removed with a number of different techniques, depending on the material of the support structure 510. In some implementations, the support structure is removed with a chemical etchant (gaseous or liquid). When using a chemical etchant, the etchant may attack the support structure and not the substrate or the liner material. In implementations where sacrificial substrate is removed with a chemical etchant or by otherwise dissolving the sacrificial substrate, the support structure may be removed in the operation of removing the sacrificial substrate if the support structure is the same material as the sacrificial substrate or a material that is attacked by the chemical etchant used to remove the sacrificial substrate. In some implementations, removing the support structure with a chemical etchant may not leave reactant residues within the open space 542 because the open space may be sealed by the liner material 532.

Returning to block 410 in FIG. 9 in which the support structure 510 is optionally removed, it is noted that the top layer material 540 deposited in block 412 of FIG. 9 may form both posts that are in contact with the substrate 502 as well as portions that are separated from the substrate, with an open space 542 between the portions and the substrate. Such an implementation is shown in FIG. 11. As shown in FIG. 11, the top layer material 540 is deposited on the substrate 502 and the liner material 532 that the removal of the sacrificial substrate 530 and the support structure 510 exposed. In some implementations, the top layer material 540 essentially replaces the support structure, forming posts 544 of the top layer material by depositing in areas in which the support structure was previously located. As in FIG. 10B, the top layer material 540 is separated from the substrate 502 by an open space 542 defined by the liner material 532. In some implementations, top layer material is separated from the substrate by about 50 nanometers to 2 micrometers.

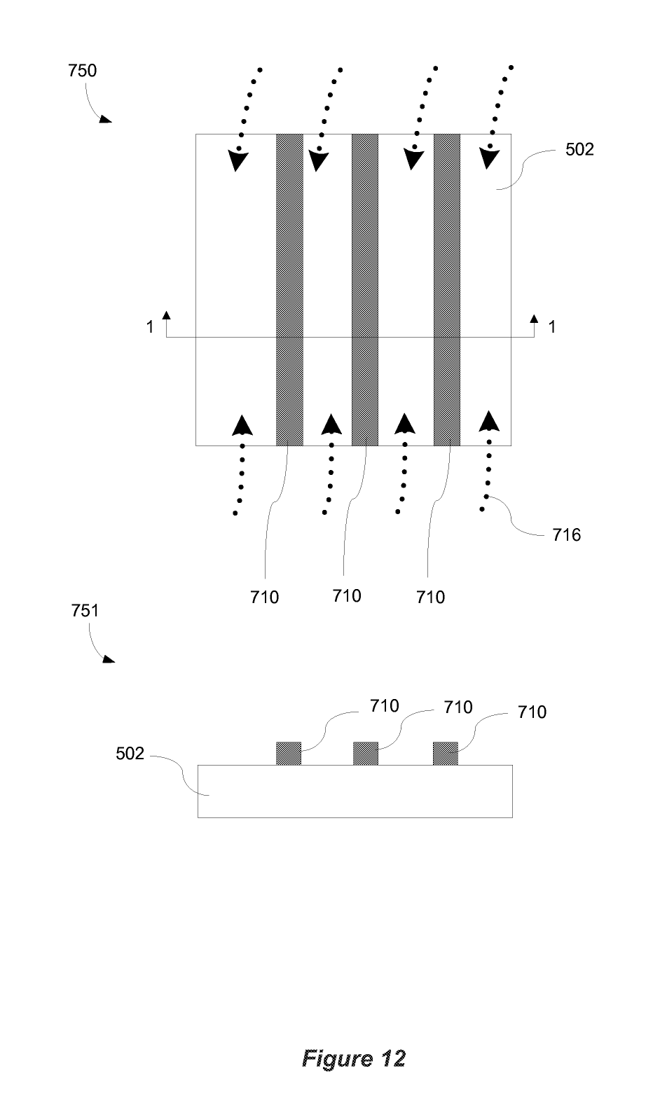

FIG. 12 shows an example of a configuration of a support structure. As noted above, a plurality of posts is one implementation of a support structure, and other configurations and geometries of support structures are possible. In one implementation, shown in FIG. 12, the support structure includes a plurality of ridges 710. Note that FIG. 12 may not be to scale. The top portion 750 of FIG. 12 depicts a top-down view of a surface of the substrate 502, and the bottom portion 751 of FIG. 12 depicts a cross-sectional view along the direction of the arrows 1-1. In some implementations, the plurality of ridges may not be straight (e.g., the ridges may be curved or include angles). The plurality of ridges also may include ridges that form passages that do not have through paths across or between two different points at the edge of the substrate; i.e., the ridges may enclose a “dead-end.” In some implementations, the spacing between two ridges is about 25 to 150 micrometers. This spacing is not necessarily uniform, however, and in some implementations may vary along the length of two ridges. Ridges of the plurality of ridges may be of almost any thickness, depending on the EMS device being fabricated. For example, ridges of the plurality of ridges may be about 0.1 to 10 micrometers thick.

The support structure 710 may be formed using any of the process described above for forming the support structure 510. A method, according to the flow diagram of FIG. 9, of forming an air gap in an EMS device with the support structure 710 shown in FIG. 12 is described below. For example, in block 404 of FIG. 9, a sacrificial substrate 530 is placed on support structure 710. In block 406, a liner material 532 is deposited on the surface of the substrate 502, the support structure 710, and the sacrificial substrate 530. In some implementations, the liner material is deposited via an ALD process. In the implementation of the support structure 710 shown in FIG. 12, the support structure 710 has a more enclosed configuration in contrast to the more open support structure 510 shown in FIGS. 10A and 10B, discussed above. With the more enclosed support structure 710, precursors for depositing the liner material are able to contact the substrate 502, the support structure 710, and the sacrificial substrate 530 from two sides, as indicated by arrows 716, whereas with the more open support structure 510, the precursors are able to contact these surfaces from multiple sides. When precursors do not have paths in which to access the substrate, the support structure, and the sacrificial substrate from multiple directions, an ALD process may use more time to allow the precursors to diffuse and access these surfaces. Further, a modified sacrificial substrate, as discussed further below, may be useful for a more enclosed support structure. In block 408, the sacrificial substrate 530 is removed. In block 412, a top layer material 540 is deposited. In some implementations, the support structure 710 may be removed in block 410.

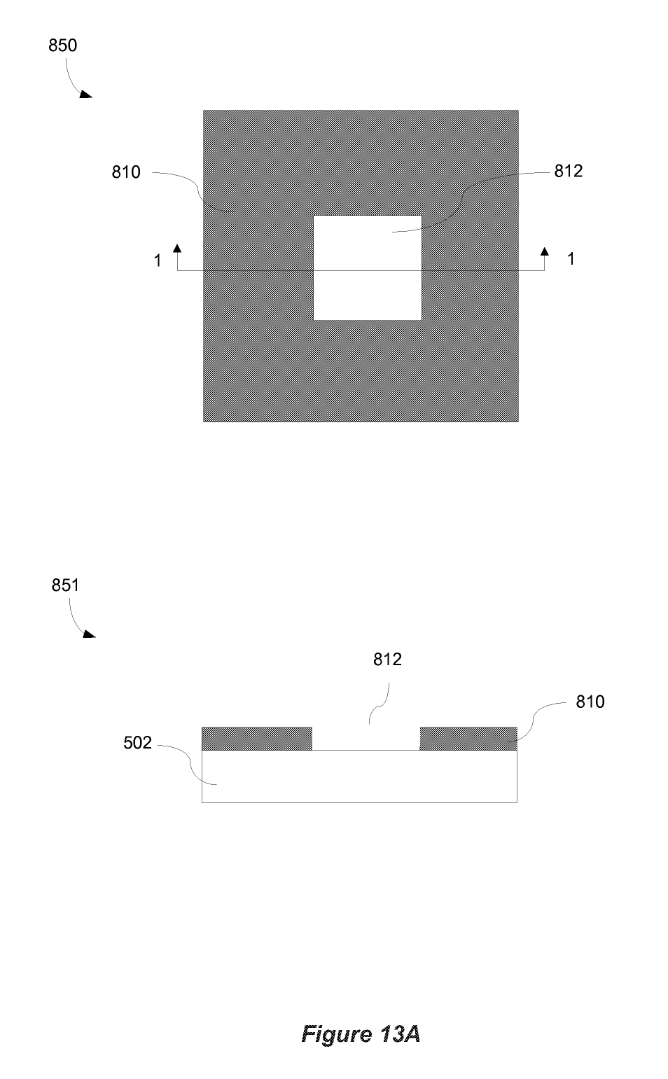

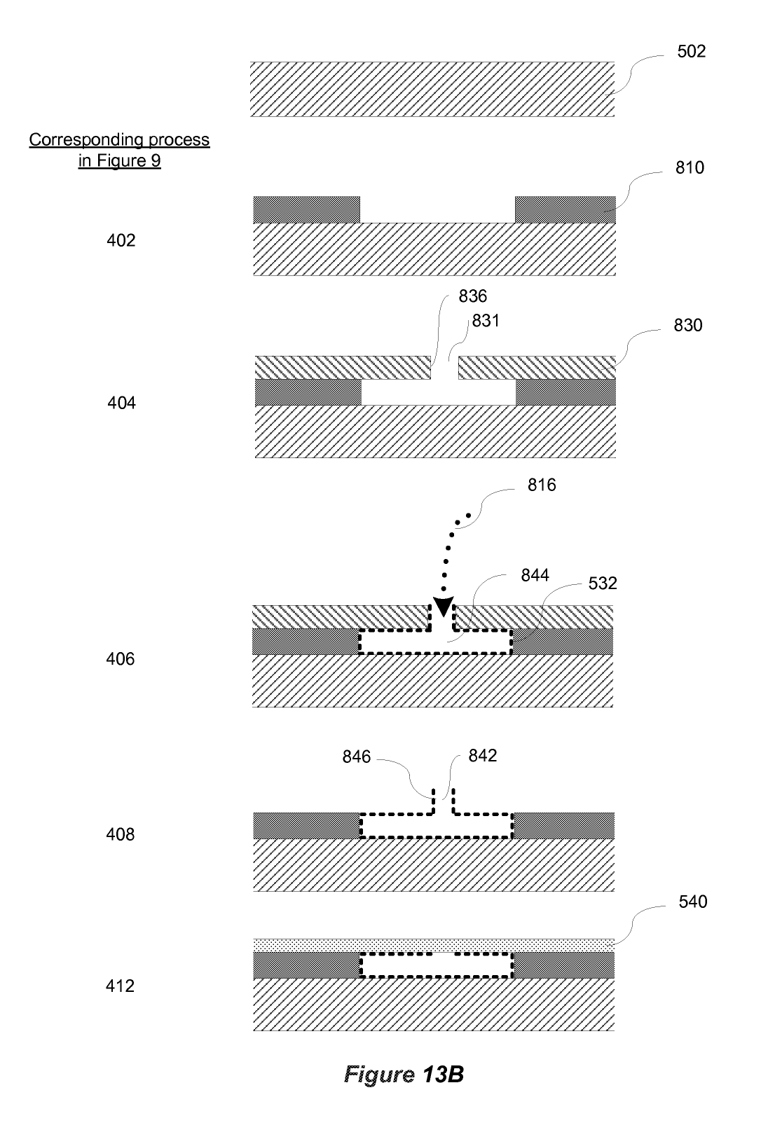

In another implementation of a support structure, the support structure completely surrounds an area of the substrate such that precursors for depositing the liner material may not enter the cavity from any side. FIG. 13A shows an example of a portion of a substrate and the materials deposited on the substrate, while FIG. 13B shows cross-sectional views of the substrate at various stages corresponding to the flow diagram of FIG. 9. Note that FIGS. 13A and 13B may not be to scale. As shown in FIG. 13A, the support structure 810 includes material that surrounds an area 812 of substrate 502. The top portion 850 of FIG. 13A depicts a top-down view of a surface of the substrate 502, and the bottom portion 851 of FIG. 13A depicts a cross-sectional view along the direction of the arrows 1-1. In some implementations, the area 812 of the substrate 502 is, for example, a rectangle, a triangle, a circle, or a hexagon, and is not limited to the square shown in FIG. 13A. Further, the area is not limited to geometric shapes, and may be an irregular shape. The area 812 of substrate 502 is generally about 25 to 150 micrometers across the widest region of the area.

A method, according to the flowchart of FIG. 9, of forming an air gap in an EMS device with the support structure 810 shown in FIG. 13A is described below. Reference is also made to FIG. 13B in the discussion below. For example, in block 402, the support structure 810 may be formed using any of the processes described above for forming the support structure 510. After forming the support structure 810, a sacrificial substrate 830 is placed on the support structure in block 404. The sacrificial substrate 830 is held on or bonded to the support structure with the processes described above. Due to area 812 of substrate 502 being an enclosed cavity (i.e., bounded by the substrate 502 and the support structure 810), the sacrificial substrate 830 includes at least one vent 831 through which precursor gases may pass. In some implementations, the vent is about 1 to 10 micrometers in diameter or about 3 micrometers in diameter. In some implementations, the vent is about 0.01 to 0.1 micrometers in diameter. Vents also may be useful in support structure implementations that are relatively enclosed and do not allow for the precursors to easily access all of the surfaces. For example, vents may find use in some areas of a sacrificial substrate that are placed on the support structures 510 or 710 shown in FIGS. 10A and 12 when precursors are not able to access some surfaces that are to be coated with the liner material.

In some implementations, the vent 831 may be formed in the sacrificial substrate 830 before the sacrificial substrate is placed on the support structure. The vent 831 may be formed using a number of different processes, including mechanical techniques or photolithography combined with etching techniques. When the vent 831 is formed before placing the sacrificial substrate 830 on the support structure, the vent needs to be lined up with the area 812 of the substrate 502 so the precursor gases can access the enclosed cavity. In other implementations, the vent 831 is formed in the sacrificial substrate 830 after placing the sacrificial substrate on the support structure using the same processes as described above.

With continued reference to FIGS. 9 and 13B, in block 406, a liner material 532 is deposited on the surface of the substrate 502, the support structure 810, and the sacrificial substrate 830. In some implementations, the liner material is deposited via an ALD process. The precursors for depositing the liner material are able to contact the substrate 502, the support structure 810, and the sacrificial substrate 830 by passing through the vent 831, as indicated by arrow 816. As explained above, ALD may deposit the liner material 532 on all exposed surfaces. This includes edges 836 of the vent 831. In some implementations, the edges 836 of the vent 831 are treated to inhibit liner material deposition, as described above. Due to the vent 831, the liner material 532 may not fully enclose open space 844.

In block 408, the sacrificial substrate 830 is removed. The sacrificial substrate is removed with the processes described above. After removing the sacrificial substrate 830, if the edges 836 of the vent 831 are not treated to inhibit deposition of the liner material 532, the liner material may include protruding edges 846. In some implementations, the protruding edge may be removed. In some implementations, the protruding edge may be broken off mechanically.

In block 412, a top layer material 540 is deposited. The top layer material 540 is deposited on the support structure 810 and the liner material 532 that the removal of the sacrificial substrate 530 exposed. Due to hole 842 in the liner material (created due to the vent 831), some of the top layer material 540 may be deposited in the open space 844, in some implementations. To avoid deposition of the top layer material 540 in the open space 844, the vent 831 may be as small as possible while still allowing the precursors for depositing the liner material to pass. In some implementations, the top layer material deposition process closes the hole 842 and a continuous layer of the top layer material 540 is formed, as shown in FIG. 13B. In other implementations, the top layer material includes a hole corresponding to the hole 842 (i.e., the top layer material 540 does not fill the hole 842 and a hole remains in top layer material). Closing the hole 842 with the top layer material might be needed for the operation of some EMS devices, including absolute pressure sensors or accelerometers, for example. In some implementations, when the protruding edges 846 are not removed, the edge material may be intermingled with the top layer material 540.

Further, in some implementations, a support structure may include combinations of the support structures shown in FIGS. 10A, 12, and 13A. For example, the support structure may include a support structure 810 (FIG. 13A) with an area 812 (FIG. 13A) that includes ridges 710 (FIG. 12) within the area 812. As another example, the support structure may include the support structure 810 with the area 812 with pillars 510 (FIG. 10A) arranged in various patterns in the area 812. Also, the process operations described above may be arranged in various combinations to form different configurations of air gaps. For example, the support structures 710 and 810 may be removed in some implementations.

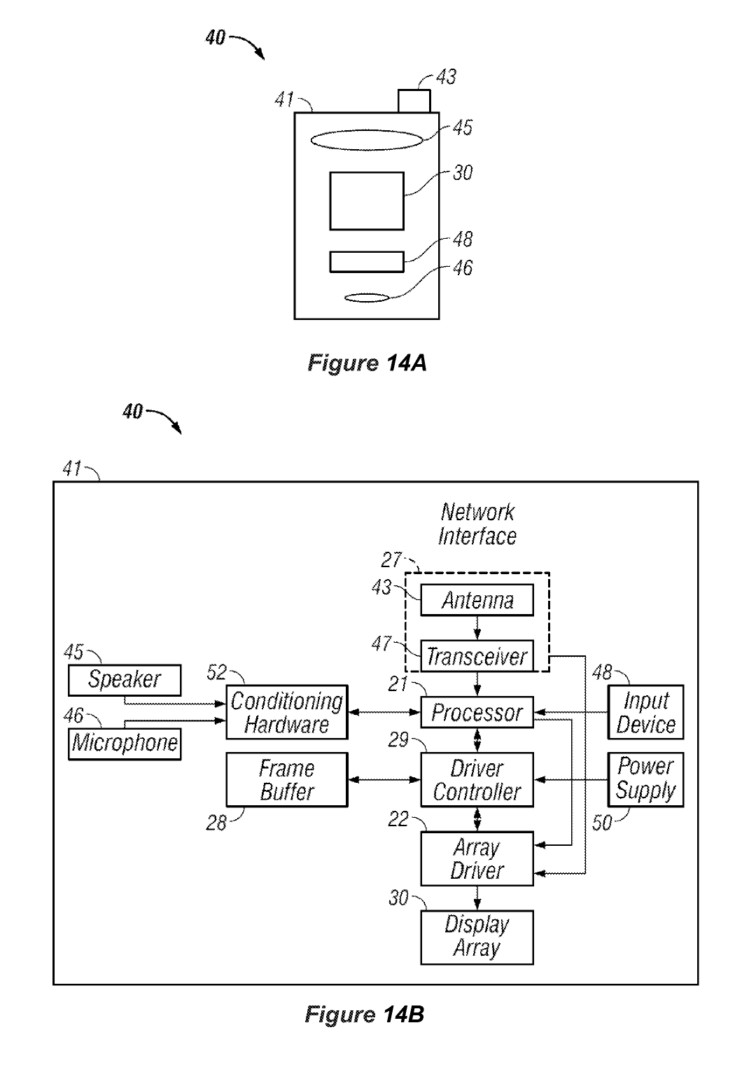

FIGS. 14A and 14B show examples of system block diagrams illustrating a display device 40 that includes a plurality of interferometric modulators. The display device 40 can be, for example, a cellular or mobile telephone. However, the same components of the display device 40 or slight variations thereof are also illustrative of various types of display devices such as televisions, e-readers and portable media players.

The display device 40 includes a housing 41, a display 30, an antenna 43, a speaker 45, an input device 48, and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber, and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include an interferometric modulator display, as described herein. The display 30 may be fabricated using any of the processes and methods disclosed herein.

The components of the display device 40 are schematically illustrated in FIG. 14B. The display device 40 includes a housing 41 and can include additional components at least partially enclosed therein. For example, the display device 40 includes a network interface 27 that includes an antenna 43 which is coupled to a transceiver 47. The transceiver 47 is connected to a processor 21, which is connected to conditioning hardware 52. The conditioning hardware 52 may be configured to condition a signal (e.g., filter a signal). The conditioning hardware 52 is connected to a speaker 45 and a microphone 46. The processor 21 is also connected to an input device 48 and a driver controller 29. The driver controller 29 is coupled to a frame buffer 28, and to an array driver 22, which in turn is coupled to a display array 30. A power supply 50 can provide power to all components as required by the particular display device 40 design.

The network interface 27 includes the antenna 43 and the transceiver 47 so that the display device 40 can communicate with one or more devices over a network. The network interface 27 also may have some processing capabilities to relieve, e.g., data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g or n. In some other implementations, the antenna 43 transmits and receives RF signals according to the BLUETOOTH standard. In the case of a cellular telephone, the antenna 43 is designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G or 4G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that is readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation, and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of pixels.

In some implementations, the driver controller 29, the array driver 22, and the display array 30 are appropriate for any of the types of displays described herein. For example, the driver controller 29 can be a conventional display controller or a bi-stable display controller (e.g., an IMOD controller). Additionally, the array driver 22 can be a conventional driver or a bi-stable display driver (e.g., an IMOD display driver). Moreover, the display array 30 can be a conventional display array or a bi-stable display array (e.g., a display including an array of IMODs). In some implementations, the driver controller 29 can be integrated with the array driver 22. Such an implementation is common in highly integrated systems such as cellular phones, watches and other small-area displays.

In some implementations, the input device 48 can be configured to allow, e.g., a user to control the operation of the display device 40. The input device 48 can include a keypad, such as a QWERTY keyboard or a telephone keypad, a button, a switch, a rocker, a touch-sensitive screen, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices. For example, the power supply 50 can be a rechargeable battery, such as a nickel-cadmium battery or a lithium-ion battery. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, e.g., a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

Various modifications to the implementations described in this disclosure may be apparent, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. The word “exemplary” is used exclusively herein to mean “serving as an example, instance, or illustration.” Any implementation described herein as “exemplary” is not necessarily to be construed as preferred or advantageous over other implementations. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of the IMOD as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A method comprising:
depositing a liner material on an area of a surface of a substrate, exposed surfaces of a support structure, and an interior surface of a sacrificial substrate, the area of the surface of the substrate being exposed by the support structure on the surface of the substrate, the sacrificial substrate being on the support structure, the interior surface of the sacrificial substrate facing and spaced apart from the area of the surface of the substrate;
removing the sacrificial substrate to expose a first area of the liner material; and
depositing a top layer material on the first area of the liner material, the area of the surface of the substrate and the top layer material being separated from one another by an open space defined by the liner material.

2. The method of claim 1, wherein depositing the liner material is performed via an atomic layer deposition process.

3. The method of claim 1, wherein the sacrificial substrate includes at least one vent configured to allow precursors used in depositing the liner material to access regions of a space defined by the area of the surface of the substrate, the support structure, and the interior surface of the sacrificial substrate.

4. The method of claim 1, wherein the support structure surrounds the area of the surface of the substrate, and wherein the sacrificial substrate includes at least one vent configured to allow precursors used in depositing the liner material to access the area of the surface of the substrate, the support structure, and the interior surface of the sacrificial substrate.

5. The method of claim 1, wherein removing the sacrificial substrate further exposes an area of the support structure.

6. The method of claim 1, wherein the separation of the area of the surface of the substrate and the top layer material is about 50 nanometers to 2 micrometers.

7. The method of claim 1, wherein the support structure is formed by a method including embossing the surface of the substrate.

8. The method of claim 1, wherein the support structure is formed by a method including depositing a material on the surface of the substrate, and removing regions of the deposited material.

9. The method of claim 1, wherein the support structure is formed by a method including depositing a photoresist on the surface of the substrate, patterning the photoresist, removing regions of the photoresist to expose regions of the surface of the substrate, depositing a material on the exposed regions of the surface of the substrate to form the support structure, and removing the remaining photoresist.

10. The method of claim 1, wherein the support structure includes at least one of a plurality of posts or a plurality of ridges.

11. The method of claim 1, wherein the support structure includes a plurality of posts, and wherein the plurality of posts are about 25 to 125 micrometers apart from one another.

12. The method of claim 1, further comprising:
treating at least a region of an exterior surface of the sacrificial substrate to inhibit deposition of the liner material on the region of the exterior surface.

13. The method of claim 1, wherein the top layer material is deposited via a physical vapor deposition process.

14. The method of claim 1, wherein the interior surface of the sacrificial substrate is substantially parallel to the area of the surface of the substrate.

15. The method of claim 1, wherein the liner material has a thickness large enough such that the liner material does not break during deposition of the top layer material.

16. The method of claim 1, wherein the support structure is bonded to the support structure with a bonding material.

17. The method of claim 16, wherein the bonding material includes a photoresist.

18. The method of claim 1, wherein the sacrificial substrate is removed with a chemical etchant.

19. The method of claim 1, wherein the support structure includes SiO₂.

20. The method of claim 1, wherein the liner material includes Al₂O₃.

21. The method of claim 1, wherein the top layer material includes at least one of Al, Ni, or SiON.

22. The method of claim 1, further comprising:
removing the support structure to expose a second area of the liner material; and
depositing the top layer material on the first area and the second area of the liner material, the area of the surface of the substrate and the top layer material being separated from one another in one or more regions by an open space defined by the liner material.

23. A device made in accordance with the method of claim 1.

24. A method comprising:
depositing a photoresist on an interior surface of a sacrificial substrate, the photoresist configured to bond the sacrificial substrate to a support structure on a surface of a substrate, the support structure including a plurality of posts exposing an area of the surface of the substrate;
bonding the sacrificial substrate to the support structure, the interior surface of the sacrificial substrate facing and spaced apart from the area of the surface of the substrate;
depositing a liner material via an atomic layer deposition process on the area of the surface of the substrate, a portion of the support structure, and the interior surface of the sacrificial substrate;
removing the sacrificial substrate by releasing the photoresist to expose an area of the support structure and an area of the liner material; and
depositing a top layer material on the area of the support structure and the area of the liner material, the area of the surface of the substrate and the top layer material being separated from one another by an open space defined by the liner material.

25. The method of claim 24, wherein the separation of the area of the surface of the substrate and the top layer material is about 50 nanometers to 2 micrometers.

26. The method of claim 24, wherein the top layer material is deposited via a physical vapor deposition process.

27. An apparatus comprising:
a substrate having a surface;
a support structure on the surface of the substrate;
a top layer material on the support structure, wherein the top layer material, the substrate, and the support structure together define an open space; and
a liner material on surfaces of the top layer material, the substrate, and the support structure that face the open space, wherein the liner material has a thickness large enough such that the liner material would not break during deposition of the top layer material.

28. The apparatus of claim 27, wherein a separation of the surface of the substrate and the top layer material is about 50 nanometers to 2 micrometers.

29. The apparatus of claim 27, further comprising:
a display;
a processor configured to communicate with the display, the processor configured to process image data; and
a memory device configured to communicate with the processor.

30. The apparatus of claim 29, further comprising:
a driver circuit configured to send at least one signal to the display; and
a controller configured to send at least a portion of the image data to the driver circuit.

31. The apparatus of claim 29, further comprising:
an image source module configured to send the image data to the processor.

32. The apparatus of claim 31, wherein the image source module includes at least one of a receiver, transceiver, and transmitter.

33. The apparatus of claim 29, further comprising:
an input device configured to receive input data and to communicate the input data to the processor.
